(19) United States
(12) Patent Application Publication
(10) Pub. No.: US 2026/0084441 A1
(43) Pub. Date: Mar. 26, 2026

(54) PRINTING APPARATUS AND CONTROL METHOD

(71) Applicant: CANON KABUSHIKI KAISHA, Tokyo (JP)

(72) Inventors: Kenji Kubozono, Tokyo (JP); Takahiro Miyazawa, Shizuoka (JP); Shinya Ishitsuka, Tokyo (JP); Takayuki Sekine, Kanagawa (JP)

(21) Appl. No.: 19/330,893

(22) Filed: Sep. 17, 2025

(30) Foreign Application Priority Data
Sep. 20, 2024 (JP) 2024-164294
Nov. 27, 2024 (JP) 2024-206408

(51) Int. Cl. B41J 11/00; B41J 25/00

(52) U.S. Cl. CPC B41J 11/008; B41J 11/0065; B41J 11/0095; B41J 25/005

(57) ABSTRACT

A printing apparatus includes: a carriage movable in a width direction intersecting a conveyance direction; a first detection unit provided on one side of the carriage in the width direction and capable of detecting an end portion of the print medium; and a second detection unit provided on the other side of the carriage in the width direction and capable of detecting the end portion, at least one of the first and second detection units includes: a light emitting unit configured to emit light to a platen and the print medium; a first light receiving unit capable of receiving reflected light from the platen and the print medium; and a second light receiving unit capable of receiving the reflected light from the platen and the print medium, overlapping the first light receiving unit in the conveyance direction, and spaced apart from the first light receiving unit in the width direction.

### BACKGROUND

### Field of the Technology

The present disclosure relates to a printing apparatus and a control method.

### Description of the Related Art

Assume a case where a printing apparatus configured to perform printing on a print medium by ejecting ink by an inkjet method performs marginless printing in which printing is performed without a margin provided in an end portion of the print medium. In this case, if an accuracy of detecting an end portion position of the print medium is low, the low detection accuracy provokes soiling in the apparatus and formation of a margin. Japanese Patent Laid-Open No. 2004-182361 discloses a technique in which a single detection part is used to detect the end portion position of the print medium based on a detection signal generated depending on reflected light from the print medium.

However, in the technique of Japanese Patent Laid-Open No. 2004-182361, in the case where the detection part provided on one side of a print head in a scanning direction is used to detect both end portions of the print medium in the scanning direction, a wide scanning range needs to be provided, and this increases a time period required for printing.

### SUMMARY

The present disclosure has been made in view of the above-mentioned problem, and provides a technique that can suppress an increase in a time period required for printing.

A printing apparatus according to some embodiments includes a supporting unit configured to support a conveyed print medium; a carriage in which a print head configured to perform printing by ejecting ink to the print medium is mounted, the carriage movable in a width direction of the print medium intersecting a conveyance direction of the print medium; a first detection unit provided on one side of the carriage in the width direction and capable of detecting an end portion of the print medium in the width direction; and a second detection unit provided on the other side of the carriage in the width direction and capable of detecting the end portion of the print medium in the width direction, wherein at least one of the first detection unit and the second detection unit includes: a light emitting unit configured to emit light to the supporting unit and the print medium supported on the supporting unit; a first light receiving unit capable of receiving reflected light from the supporting unit and the print medium supported on the supporting unit; and a second light receiving unit capable of receiving the reflected light from the supporting unit and the print medium supported on the supporting unit, the second light receiving unit overlapping the first light receiving unit in the conveyance direction and spaced apart from the first light receiving unit in the width direction.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective configuration diagram of a printing apparatus.

FIGS. 2A and 2B are schematic configuration diagrams of a printing part.

FIGS. 3A and 3B are schematic configuration diagrams of a first sensor and a second sensor.

FIG. 4 is a block diagram focusing on a configuration of a control system of the printing apparatus.

FIGS. 5A to 5C are diagrams explaining changes in an output voltage of the first sensor.

FIG. 6 is a diagram illustrating an output waveform illustrating changes in the output voltage of the first sensor.

FIG. 7 is a diagram explaining an operation of the second sensor in a differential mode.

FIGS. 8A to 8C are diagrams explaining an output voltage in one of light receiving parts of the second sensor in the differential mode.

FIG. 9 is a diagram illustrating an output waveform illustrating changes in a differential signal in the differential mode.

FIG. 10 is a diagram illustrating changes in an output voltage of the second sensor in a single mode.

FIG. 11 is a flowchart illustrating details of a printing process.

FIGS. 12A to 12L are diagrams explaining detection of an end portion position of the print medium in scanning involving printing.

FIG. 13 is a diagram illustrating an outline of determination of the end portion position of the print medium.

FIG. 14 is a flowchart illustrating details of an obtaining process.

FIGS. 15A and 15B are diagrams illustrating the size of a print image relative to a print medium in micro-margin printing.

FIGS. 16A and 16B are diagrams explaining changes in a movement speed of the first sensor in passing of the end portion.

FIGS. 17A and 17B are diagrams explaining an outline of a change of a stop position of the carriage.

FIG. 18 is a flowchart illustrating details of a changing process.

FIG. 19 is a flowchart illustrating details of a modification of the changing process.

FIGS. 20A and 20B are diagrams explaining conditions in which no change of the movement speed occurs in the unit of scanning involving printing.

FIG. 21 is a diagram illustrating an example of data indicating a relationship between a correction amount and a movement speed difference.

FIGS. 22A and 22B are diagrams explaining a detection technique of the end portion position of the print medium in response to an unnecessary output.

FIG. 23 is a diagram explaining the detection technique of the end portion position of the print medium in response to the unnecessary output.

FIGS. 24A to 24D are diagrams explaining a detection technique of the end portion position of the print medium in response to an unnecessary output.

FIGS. 25A and 25B are diagrams explaining a detection technique of the end portion position of the print medium in response to an abnormal output.

### DESCRIPTION OF THE EMBODIMENTS

Examples of embodiments of a printing apparatus and a control method are explained below in detail with reference to the attached drawings. Note that the following embodiments do not limit the present disclosure, and not all of combinations of features explained in the present embodiments are necessarily essential for solving means of the present disclosure. Moreover, positions, shapes, and the like of the constituent elements described in the embodiments are merely examples, and are not intended to limit the scope of the present disclosure to these positions, shapes, and the like.

### First Embodiment

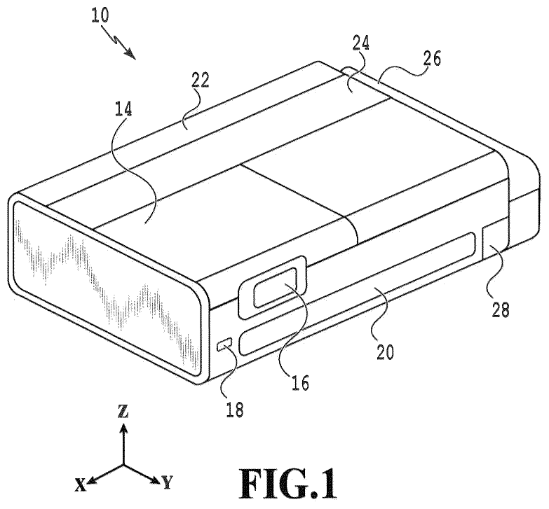

First, a printing apparatus according to a first embodiment is explained in detail with reference to FIGS. 1 to 12L.

### Configuration of Printing Apparatus

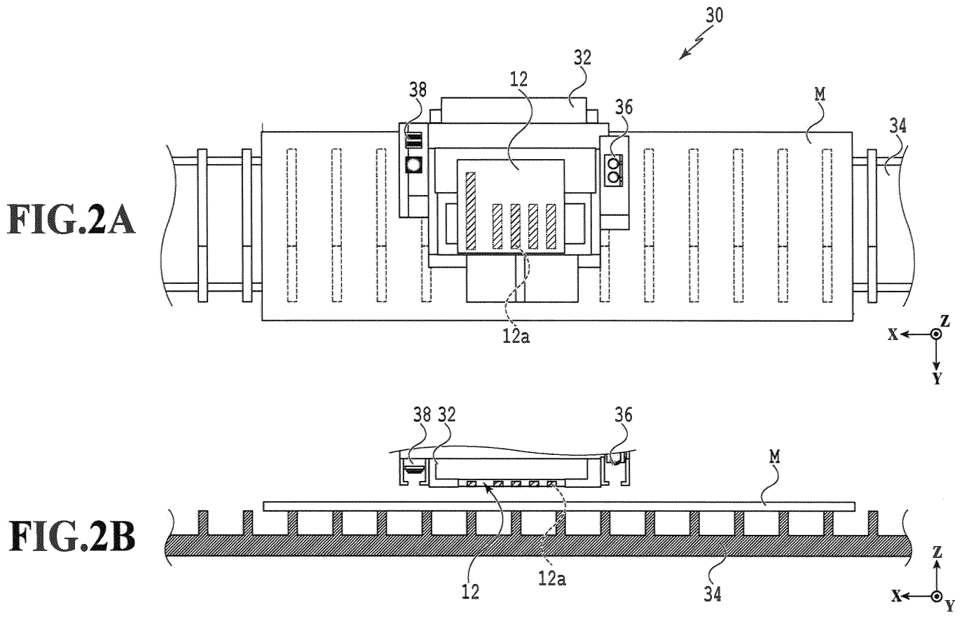

FIG. 1 is a perspective configuration diagram of the printing apparatus. FIGS. 2A and 2B are diagrams illustrating an outline of a configuration of a printing part provided inside the printing apparatus, FIG. 2A is a plan diagram, and FIG. 2B is a front diagram. In the present specification, explanation is given assuming that a direction from the right side toward the left side of the printing apparatus in the case where a viewer faces the side of the printing apparatus from which a print medium subjected to printing is discharged is an X direction, a direction from the far side (rear side) to the near side (front side) of the printing apparatus is a Y direction, and a direction from the lower side toward the upper side of the printing apparatus is a Z direction. As described above, the X direction, the Y direction, and the Z direction are each a direction from one side toward the other side, and are directions orthogonal to one another. In the present specification, each of the directions is described with “+ (plus)” attached thereto in the case of the direction from the one side toward the other side, and is described with “− (minus)” attached thereto in the case of the direction from the other side toward the one side as necessary.

In the printing apparatus 10 illustrated in FIG. 1, the printing part 30 (see FIG. 2A) configured to perform printing by ejecting ink from a print head 12 (see FIG. 2A) to a conveyed print medium M is housed in a case 14 (see FIG. 1). The printing apparatus 10 includes, on a front face, an operation part 16 configured to display various pieces of information and receive operations made by a user, a notification part 18 configured to perform notification by audio, and a discharge part 20 from which the print medium M subjected to printing is discharged. Moreover, the printing apparatus 10 includes, on the rear side, a roll holding part 22 that holds a roll formed by winding a sheet-shaped print medium M and that is capable of unwinding the roll and feeding the print medium M to the printing part 30. Furthermore, the printing apparatus 10 includes a sheet feeding part 24 capable of feeding a cut-sheet-shaped print medium M with a predetermined size to the printing part 30. Moreover, the printing apparatus 10 includes an ink tank 26 configured to store the ink to be supplied to the print head 12 and a housing portion 28 housing a waste liquid tank (not illustrated) configured to store waste ink.

The printing apparatus 10 includes a conveyance mechanism (not illustrated) that conveys the print medium M fed from the roll holding part 22 or the sheet feeding part 24 to a position where the print head 12 can perform printing and that discharges the print medium M subjected to printing from the discharge part 20, in the printing part 30 provided in the case 14. As the conveyance mechanism, various publicly-known techniques can be used, such as, for example, a configuration in which the print medium M is nipped by a drive roller and a follower roller configured to come into pressure contact with the drive roller and follow the drive roller, and the nipped print medium M is conveyed by drive of the drive roller. In the present embodiment, the print medium M is conveyed in the +Y direction.

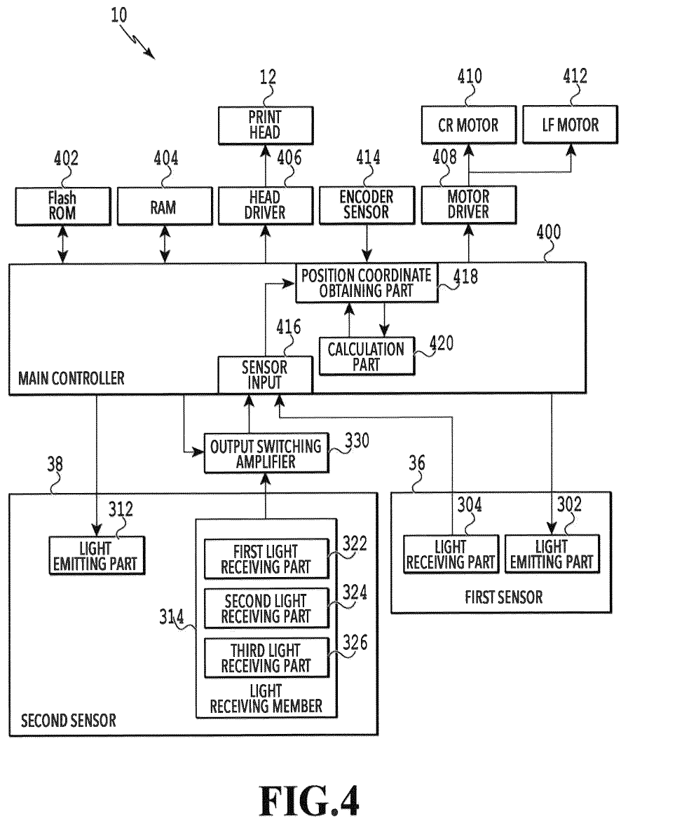

The printing part 30 includes a carriage 32 in which the print head 12 is mounted and that can be reciprocally moved in the X direction (see FIG. 2A). The carriage 32 is provided to be slidable on a guide rail (not illustrated) extending in the X direction, and is configured to be movable from the one side toward the other side (+X direction) and from the other side toward the one side (−X direction) in the X direction by drive of a carriage motor 410 (see FIG. 4). Accordingly, in the printing apparatus 10, the print head 12 mounted in the carriage 32 can be also reciprocally moved in the X direction via the carriage 32.

The printing part 30 includes a platen 34 configured to support the conveyed print medium M, at a position facing the print head 12 moved via the carriage 32. In the present embodiment, the platen 34 functions as a support part configured to support the conveyed print medium M. The printing part 30 has a configuration in which the print head 12 ejects the ink while being moved relative to the print medium M conveyed in the +Y direction and supported on the platen 34, via the carriage 32 in the width direction (±X directions) of the print medium M. In the present embodiment, the platen 34 has a characteristic of absorbing light emitted thereto and not reflecting or hardly reflecting the light emitted thereto. Note that nozzle arrays 12a formed by arranging multiple nozzles configured to eject the ink are formed on a surface of the print head 12 facing the platen 34. The nozzle arrays 12a extends in the Y direction intersecting (orthogonal to in the present embodiment) a movement direction (X direction) of the print head 12.

The printing apparatus 10 performs a printing operation in which printing is performed by ejecting the ink to the print medium M, conveyed to a printing start position by the conveyance mechanism, based on print data while moving (scanning) the print head 12 in the X direction. Next, the conveyance mechanism conveys the print medium M by a predetermined amount, and the printing operation is performed again. As described above, the printing apparatus 10 executes the printing based on the print data on the print medium M by repeatedly, alternately executing the printing operation and the conveyance operation.

The printing part 30 includes a first sensor 36 and a second sensor 38 capable of detecting end portions of the print medium M in the X direction. The first sensor 36 and the second sensor 38 are provided in the carriage 32, and are thereby configured to be reciprocally movable in the X direction via the carriage 32. The first sensor 36 is provided on the one side (right side) of the carriage 32 in the X direction. Meanwhile, the second sensor 38 is provided on the other side (left side) of the carriage 32 in the X direction. Note that, in the printing apparatus 10, the print head 12 (carriage 32) is assumed to be located at a standby position provided on the one side in the X direction in the case where no printing is performed. This standby position is provided at a position outside a printing region in which the print head 12 performs printing by ejecting the ink to the print medium M. As described in detail later, the first sensor 36 and the second sensor 38 are optical sensors. In the present embodiment, the first sensor 36 and the second sensor 38 function as a detection part capable of detecting the end portions of the print medium M in the X direction.

### First Sensor and Second Sensor

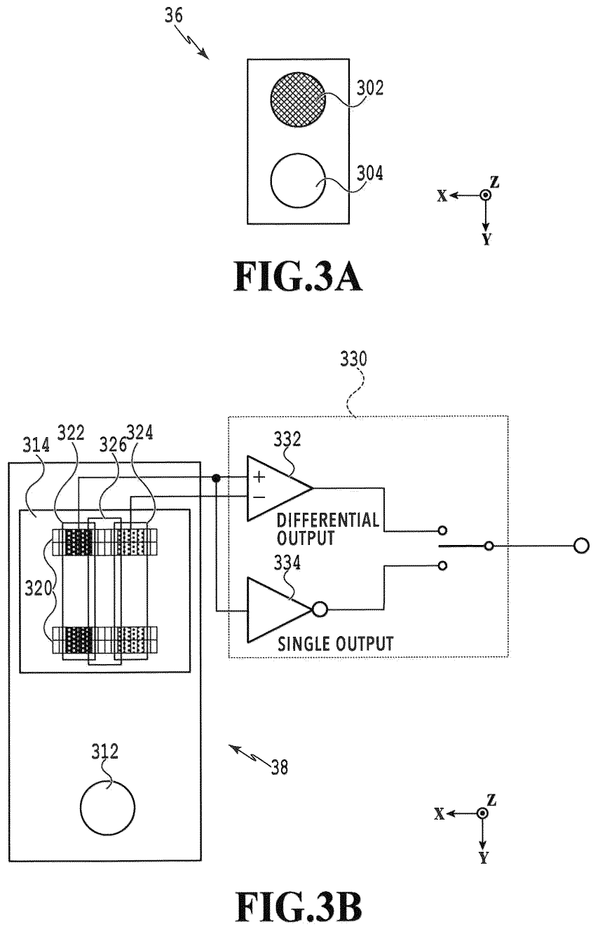

Next, configurations of the first sensor 36 and the second sensor 38 are explained. FIGS. 3A and 3B are schematic configuration diagrams of the first sensor 36 and the second sensor 38, FIG. 3A is the first sensor 36, and FIG. 3B is the second sensor 38.

The first sensor 36 includes a light emitting part 302 capable of emitting light to the platen 34 and the print medium M supported on the platen 34 and a light receiving part 304 capable of receiving reflected light from the platen 34 and the print medium M (see FIG. 3A). Although the light emitting part 302 is arranged on one side (rear side) of the light receiving part 304 in the Y direction in the present embodiment, the arrangement is not limited to this. For example, the light emitting part 302 may be arranged on the other side (front side) of the light receiving part 304 in the Y direction, or on the one side or the other side of the light receiving part 304 in the X direction.

The second sensor 38 includes a light emitting part 312 capable of emitting light to the platen 34 and the print medium M supported on the platen 34 and a light receiving member 314 capable of receiving reflected light from the platen 34 and the print medium M (see FIG. 3B). Although the light emitting part 312 is arranged on the other side of the light receiving member 314 in the Y direction in the present embodiment, the arrangement is not limited to this. For example, the light emitting part 312 may be arranged on the one side of the light receiving member 314 in the Y direction, or on the one side or the other side of the light receiving member 314 in the X direction.

The light receiving member 314 includes a light receiving element part 320 in which multiple light receiving elements are arranged in a matrix in the X direction and the Y direction. Specifically, in the light receiving element part 320, multiple light receiving element arrays in which a predetermined number of light receiving elements are arranged side by side in the Y direction are arranged in the X direction. Note that, in the present specification, in each of the diagrams including FIG. 3B in which the light receiving element part 320 is illustrated, illustration of the light receiving elements located in the middle in the Y direction is omitted. Moreover, in the light receiving member 314, three light receiving parts are formed in the light receiving element part 320. Specifically, one or multiple light receiving element arrays located on the other side of the light receiving element part 320 in the X direction form a first light receiving part 322. Moreover, one or multiple light receiving element arrays located on the one side of the light receiving element part 320 in the X direction form a second light receiving part 324. Note that, in the present embodiment, the first light receiving part 322 and the second light receiving part 324 overlap each other in the Y direction, and are provided to be spaced apart from each other in the X direction. Moreover, one or multiple light receiving element arrays that are located between the first light receiving part 322 and the second light receiving part 324 in the light receiving element part 320 and that are not used in the first light receiving part 322 and the second light receiving part 324 form a third light receiving part 326. Note that the light receiving element arrays to be used in each light receiving part may be fixed, or may be configured to be capable of being increased or reduced.

An output from each of the light receiving parts in the light receiving member 314 is inputted into an output switching amplifier 330. In the output switching amplifier 330, an output method can be switched. Specifically, the output switching amplifier 330 is configured to allow a main controller 400 to perform switching between a differential mode based on output values of the first light receiving part 322 and the second light receiving part 324 and a single mode based on an output value of the third light receiving part 326. In the differential mode, outputs from the first light receiving part 322 and the second light receiving part 324 are inputted into a differential amplifier 332 provided in the output switching amplifier 330. In the single mode, the output from the third light receiving part 326 is inputted into a single amplifier 334 provided in the output switching amplifier 330.

### Configuration of Control System of Printing Apparatus

Next, a configuration of a control system of the printing apparatus 10 is explained. FIG. 4 is a block diagram illustrating the configuration of the control system of the printing apparatus 10.

The printing apparatus 10 includes the main controller 400 configured to control operations of the entire printing apparatus 10. The main controller 400 executes various processes based on programs and data held in a flash ROM 402 and a RAM 404. The flash ROM 402 is a non-volatile storage, and stores programs, parameters, correction data, and the like to be used in the various processes. The RAM 404 is a volatile storage, and temporarily holds programs, data, and the like.

The main controller 400 controls ejection of the ink from the print head 12 via a head driver 406. Moreover, the main controller 400 controls drive of various motors via a motor driver 408. The motors whose drive is controlled by the motor driver 408 include a carriage (CR) motor 410 for moving the carriage 32 in the X direction and a line feed (LF) motor 412 for driving the drive roller (not illustrated) configured to convey the print medium M. In addition to these motors, although illustration is omitted, a motor configured to drive a maintenance part (not illustrated) for maintaining and recovering an ejection performance of the ink from the nozzles in the print head 12 and the like are also controlled via the motor driver 408. The main controller 400 detects drive amounts of the respective motors by using encoder sensors 414 corresponding to the respective motors, and controls the drive of the motors. Encoder scales read by the encoder sensors 414 are linear scales and rotary scales. In both types of scales, a drive amount is detected based on a count number of the sensor.

Moreover, the main controller 400 is connected to the first sensor 36 and the second sensor 38. In the first sensor 36, drive of the light emitting part 302 is controlled by the main controller 400. Moreover, in the light receiving part 304 of the first sensor 36, a signal based on an amount of received light is amplified to a level suiting the main controller 400, and is obtained by a sensor input 416 of the main controller 400 as an analog input level. In the second sensor 38, drive of the light emitting part 312 is controlled by the main controller 400. Moreover, in each of the light receiving parts in the light receiving member 314 of the second sensor 38, a signal based on an amount of received light is converted in the differential amplifier 332 (see FIG. 3B) or the single amplifier 334 of the output switching amplifier 330, and is then amplified to the level suiting the main controller 400. In the main controller 400, the sensor input 416 obtains the amplified signal as an analog input level. The printing apparatus 10 is configured such that a gain of the differential amplifier 332 can be changed from the main controller 400 to suit a received light signal level in an analog manner. The main controller 400 obtains position coordinates of positions detected by the first sensor 36 and the second sensor 38 in a position coordinate obtaining part 418 based on the signals obtained from the first sensor 36 and the second sensor 38, and calculates each of the end portions of the print medium Min the X direction in a calculation part 420.

### Detection Operations by First Sensor and Second Sensor

The print medium M is generally white, and the platen 34 has a characteristic of absorbing light, that is black in the present embodiment. Accordingly, the light emitted from each light emitting part is almost entirely reflected on the print medium M, and is almost entirely absorbed on the platen 34. Accordingly, a difference in the amount of light received in the light receiving part occurs between the print medium M and the platen 34. The first sensor 36 and the second sensor 38 detect each end portion of the print medium M based on this difference in the amount of light received in the light receiving part that occurs between the print medium M and the platen 34.

### Detection Operation by First Sensor 36

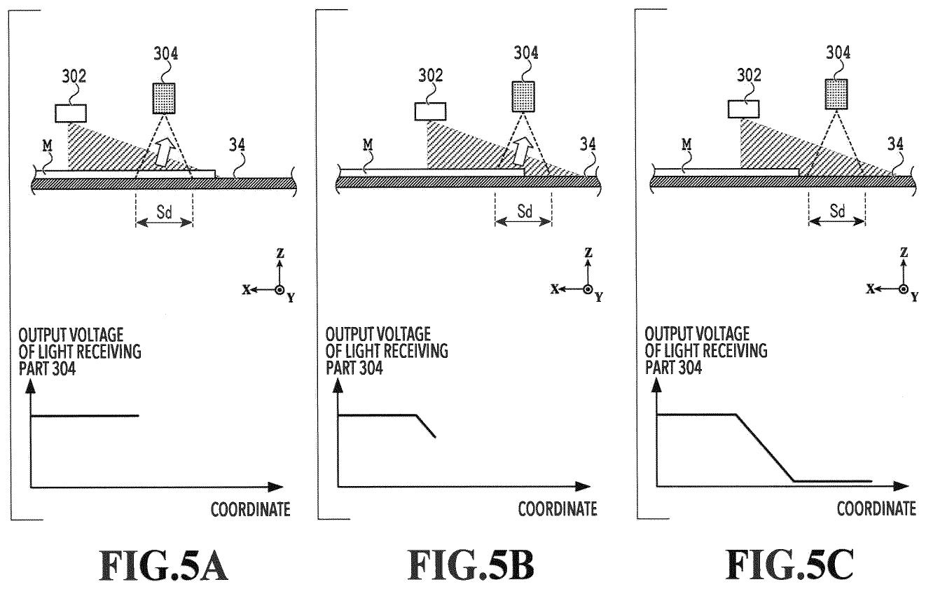

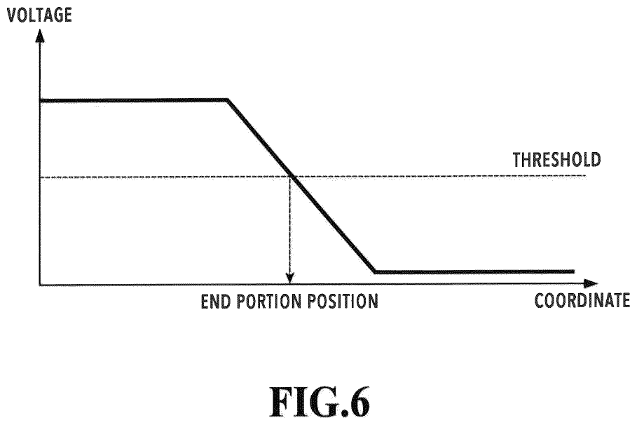

First, an outline of a detection operation by the first sensor 36 is explained. FIGS. 5A to 5C are diagrams explaining changes in the output of the first sensor 36 in three different states. FIG. 6 is a diagram illustrating an example of an output waveform of the first sensor 36. Note that, in FIGS. 5A to 5C, the light emitting part 302 is arranged at a position away from the light receiving part 304 in the X direction to facilitate understanding.

FIGS. 5A to 5C illustrate a case where the first sensor 36 is moved relative to the print medium M supported. on the platen 34 from the other side toward the one side in the X direction (-X direction), above the print medium M, and the situation sequentially changes from the state illustrated in FIG. 5A to the state illustrated in FIG. 5B, and then to the state illustrated in FIG. 5C. The light receiving part 304 receives reflected light from within a spot diameter Sd of the light receiving part 304, and outputs a voltage corresponding to an amount of light by converting the received light to the voltage. The light emitting part 302 emits light to the entire region within the spot diameter Sd of the light receiving part 304.

In the case where the print medium M is located in the entire region of the spot diameter Sd, the amount of light received in the light receiving part 304 is maximized by the reflected light from the print medium M located in the spot diameter Sd, and an output voltage of the light receiving part 304 takes a maximum value (see FIG. 5A).

In the case where the first sensor 36 is moved from the other side toward the one side in the X direction from the state of FIG. 5A and the platen 34 is located in the region within the spot diameter Sd, the amount of light reflected from the spot diameter Sd decreases as a proportion of an area occupied by the platen 34 increases in the region. Accordingly, the amount of light received in the light receiving part 304 decreases in response to the movement of the first sensor 36, and the output voltage of the light receiving part 304 gradually decreases (see FIG. 5B).

Then, in the case where the first sensor 36 is further moved from the other side toward the one side in the X direction from the state of FIG. 5B and no print medium M is located, that is only the platen 34 is located in the entire region within the spot diameter Sd, almost no light is reflected from within the spot diameter Sd. Accordingly, the output voltage of the light receiving part 304 takes a minimum value (see FIG. 5C).

The output waveform based on the above-mentioned changes in the output voltage is as illustrated in FIG. 6. In a portion near the end portion of the print medium M where the proportion of the area occupied by the print medium M in the spot diameter Sd changes, the output waveform changes, and the value of the output voltage decreases in response to the decrease of the proportion. Accordingly, the output voltage at a position corresponding to an end portion position of the print medium M is set as a threshold based on this change in the output waveform, and the position of the end portion of the print medium M is calculated based on a coordinate in the case where the output voltage passes this threshold. For example, this threshold is determined through experiments depending on the type and the like of the print medium M to be used.

### Detection Operation by Second Sensor 38

Next, an outline of a detection operation by the second sensor 38 is explained. Note that the second sensor 38 is configured such that the mode of the second sensor 38 is selectable between the differential mode in which the first light receiving part 322 and the second light receiving part 324 are used and the single mode in which the third light receiving part 326 is used. Specifically, the second sensor 38 detects each end portion of the print medium M in the X direction by using the first light receiving part 322 and the second light receiving part 324 in the case where the differential mode is set, and detects the end portion by using the third light receiving part 326 in the case where the single mode is set.

### Detection Operation in Differential Mode

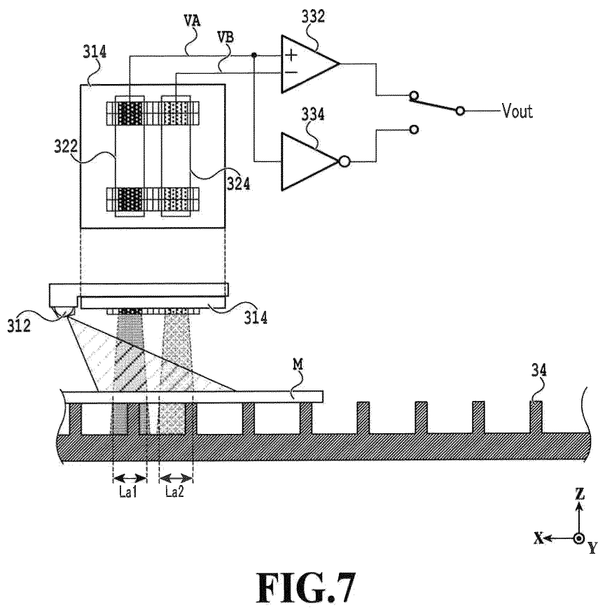

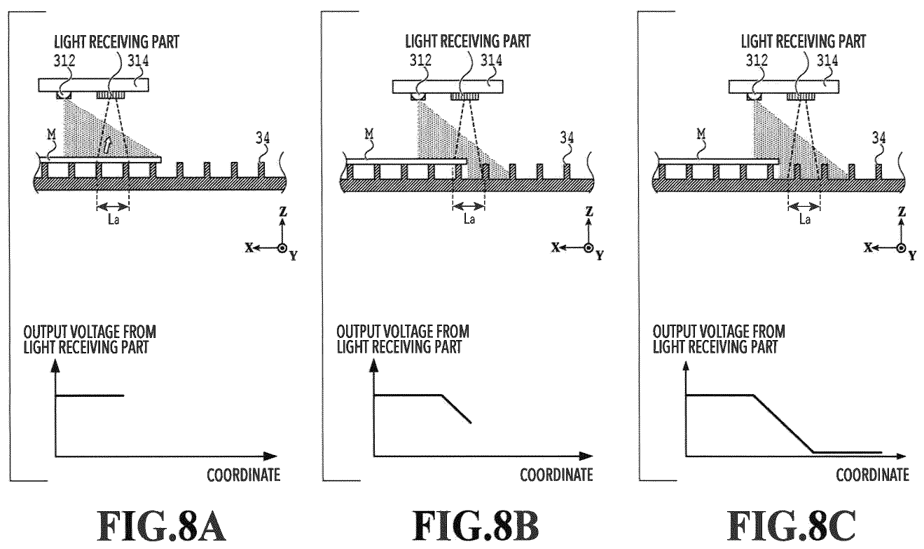

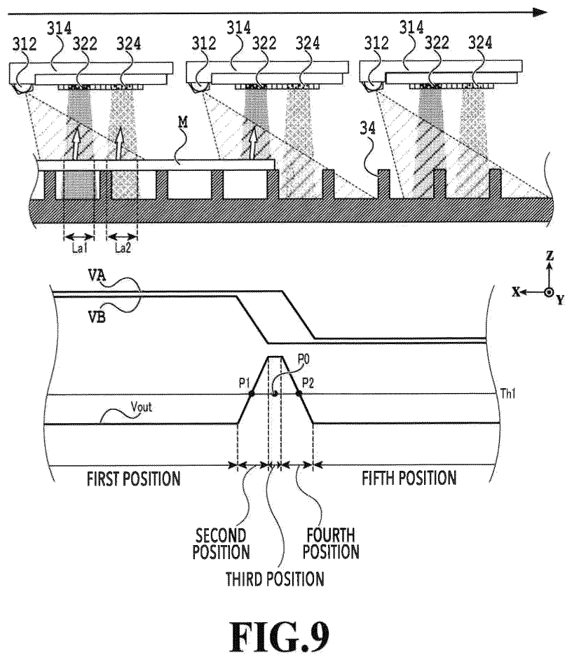

First, an outline of a detection operation in the differential mode is explained. FIG. 7 is a diagram explaining emission of light from the light emitting part 312 and reception of light in the first light receiving part 322 and the second light receiving part 324 in the second sensor 38. FIGS. 8A to 8C are diagrams illustrating changes in the outputs from the first light receiving part 322 and the second light receiving part 324 in three different states. FIG. 9 is a diagram illustrating output waveforms of the first light receiving part 322 and the second light receiving part 324 and an output waveform of the differential amplifier 332 in the case where a relative positional relationship between the second sensor and the print medium M supported on the platen 34 is changed in the X direction. Note that, in FIGS. 7 to 9, the light emitting part 312 is arranged at a position away from the light receiving member 314 in the X direction to facilitate understanding.

In the differential mode, the first light receiving part 322 receives reflected light in a light reception region Lal from which the first light receiving part 322 can receive light, and outputs a voltage corresponding to an amount of light by converting the received light to the voltage. Moreover, in a differential mode, the second light receiving part 324 receives reflected light in a light reception region La2 from which the second light receiving part 324 can receive light, and outputs a voltage corresponding to an amount of light by converting the received light to the voltage. Note that the light reception region Lal and the light reception region La2 do not overlap each other in the X direction, and have the same area. Note that having the same area is not limited to having precisely the same area, and also includes the case where a difference between the areas of the two light reception regions Lal and La2 is within a predetermined range.

In the differential mode, the output voltages from the first light receiving part 322 and the second light receiving part 324 are inputted into the differential amplifier 332. In the differential amplifier 332, a difference between a voltage value VA outputted from the first light receiving part 322 and a voltage value VB outputted from the second light receiving part 324 is amplified, and a differential signal Vout is outputted. The light emitting part 312 emits light to the entire region in the light reception region La1 of the first light receiving part 322 and the entire region in the light reception region La2 of the second light receiving part 324.

Changes in the output waveforms of the first light receiving part 322 and the second light receiving part 324 in the differential mode are explained with reference to FIGS. 8A to 8C while focusing on one of the light receiving parts. FIGS. 8A to 8C illustrate the case where the second sensor 38 is moved relative to the print medium M supported on the platen 34 from the other side toward the one side in the X direction (−X direction), above the print medium M, and the situation sequentially changes from the state illustrated in FIG. 8A to the state illustrated in FIG. 8B, and then to the state illustrated in FIG. 8C. In the case where the print medium M is located in the entire region of the light reception region La, the amount of light received in the light receiving part is maximized by the reflected light from the print medium M located in the light reception region La, and an output voltage of the light receiving part is maximized (see FIG. 8A).

In the case where the second sensor 38 is moved from the other side toward the one side in the X direction from the state of FIG. 8A and the platen 34 is located in the region within the light reception region La, the amount of light reflected from the light reception region La decreases as a proportion of an area occupied by the platen 34 increases in the region. Accordingly, the amount of light received in the light receiving part decreases in response to the movement of the second sensor 38, and the output voltage of the light receiving part gradually decreases (see FIG. 8B).

Then, in the case where the second sensor 38 is further moved from the other side toward the one side in the X direction from the state of FIG. 8B and no print medium M is located, that is only the platen 34 is located in the entire region within the light reception region La, almost no light is reflected from within the light reception region La. Accordingly, the output voltage of the light receiving part takes a minimum value (see FIG. 8C).

In the second sensor 38, the output voltages change as described above in the first light receiving part 322 and the second light receiving part 324. Note that, since the first light receiving part 322 and the second light receiving part 324 are provided at different positions in the X direction, positions where the output voltages change (output waveforms tilt) are shifted from each other in the X direction. Then, the output voltages of the first light receiving part 322 and the second light receiving part 324 are inputted into the differential amplifier 332. In the differential amplifier 332, a differential signal Vout is outputted based on a difference between the output voltage of the first light receiving part 322 and the output voltage of the second light receiving part 324. Accordingly, in the output waveform illustrating the changes in the differential signal Vout, a waveform with a predetermined shape is formed in a region where there is the difference between the output voltage of the first light receiving part 322 and the output voltage of the second light receiving part 324, that is near the end portion of the print medium M. The output waveform of the differential amplifier 332 is explained below with reference to FIG. 9.

Assume that the second sensor 38 is at a first position where the print medium M is located in the entire region of each of the light reception region La1 of the first light receiving part 322 and the light reception region La2 of the second light receiving part 324. In this case, the output voltage VA of the first light receiving part 322 and the output voltage VB of the second light receiving part 324 both take the maximum values and are the same value. Accordingly, at the first position, the difference between the output voltage VA and the output voltage VB is 0 V, and the differential signal Vout from the differential amplifier 332 is 0 V. Note that, in FIG. 9, a portion of the output waveform of the output voltage VA and a portion of the output waveform of the output voltage VB where the output voltages are the same are illustrated with a gap provided between the output waveforms to facilitate understanding.

In the case where the second sensor 38 moves from the other side toward the one side in the X direction from the first position, the second sensor 38 transitions to a second position where the print medium M is located in the entire region of the light reception region Lal of the first light receiving part 322 and the platen 34 is located in part of the light reception region La2 of the second light receiving part 324. At the second position, there is a difference between the output voltage VA of the first light receiving part 322 and the output voltage VB of the second light receiving part 324. Specifically, the output voltage VA of the first light receiving part 322 is higher than the output voltage VB of the second light receiving part 324. More specifically, the output voltage VA of the first light receiving part 322 is maintained at the maximum value, while the output voltage VB of the second light receiving part 324 gradually decreases with the movement. Accordingly, at the second position, the difference between the output voltage VA and the output voltage VB gradually increases with the movement, and the differential signal Vout thereby increases.

Moreover, in the case where the second sensor 38 is further moved from the other side toward the one side in the X direction from the second position, the second sensor 38 transitions to a third position. At the third position, the print medium M is located in the entire region of the light reception region La1 of the first light receiving part 322, and the platen 34 is located in the entire region of the light reception region La2 of the second light receiving part 324. At the third position, the output voltage VA of the first light receiving part 322 maintains the maximum value, while the output voltage VB of the second light receiving part 324 reaches and maintains a minimum value. Accordingly, the difference between the output voltage VA and the output voltage VB is maximized, and the differential signal Vout takes a maximum value.

Then, in the case where the second sensor 38 is further moved from the other side toward the one side in the X direction from the third position, the second sensor 38 transitions to a fourth position. At the fourth position, the platen 34 is located in part of the light reception region La1 of the first light receiving part 322, and the platen 34 is located in the entire region of the light reception region La2 of the second light receiving part 324. At the fourth position, the output voltage VA of the first light receiving part 322 gradually decreases with the movement, while the output voltage VB of the second light receiving part 324 maintains the minimum value. Accordingly, at the fourth position, the difference between the output voltage VA and the output voltage VB gradually decreases with the movement, and the differential signal Vout thereby decreases.

Then, in the case where the second sensor 38 is further moved from the other side toward the one side in the X direction from the fourth position, the second sensor 38 transitions to a fifth position. At the fifth position, the platen 34 is located in the entire region of each of the light reception region Lal of the first light receiving part 322 and the light reception region La2 of the second light receiving part 324. At the fifth position, the output voltage VA of the first light receiving part 322 and the output voltage VB of the second light receiving part 324 both take the minimum values and are the same value. Accordingly, at the fifth position, the difference between the output voltage VA and the output voltage VB is 0 V, and the differential signal Vout from the differential amplifier 332 is 0 V.

A position Pl where the output Vout of the differential amplifier 332 exceeds a first threshold Th1 set in advance and a position P2 where the output Vout falls below the first threshold Th1 are detected for such changes in the output Vout, and a midpoint PO of the positions Pl and P2 is obtained as the end portion position of the print medium M. Note that, for example, the first threshold Th1 as described above is determined through experiments depending on the type and the like of the print medium M to be used.

### Detection Operation in Single Mode

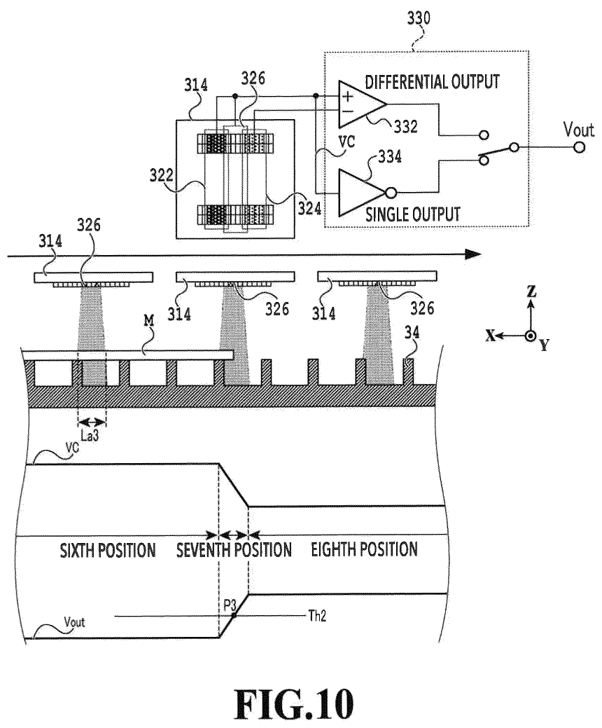

Next, an outline of a detection operation in the single mode is explained. FIG. 10 is a diagram illustrating an output waveform corresponding to changes in an output voltage VC of the third light receiving part 326 and an output waveform corresponding to changes in an output signal Vout of the single amplifier 334 in the case where a relative positional relationship between the second sensor and the print medium M supported on the platen 34 is changed in the X direction. Note that, in FIG. 10, the light emitting part 312 is omitted to facilitate understanding.

In the single mode, the third light receiving part 326 receives reflected light in a light reception region La3 from which the third light receiving part 326 can receive light, and outputs a voltage corresponding to an amount of light by converting the received light to the voltage. The output voltage from the third light receiving part 326 is inputted into the single amplifier 334, amplified and inverted in the single amplifier 334, and is outputted. The light emitting part 312 emits light to the entire region within the light reception region La3 of the third light receiving part 326.

Changes in the output waveform of the third light receiving part 326 and changes in the output waveform of the single amplifier 334 in the single mode are explained with reference to FIG. 10. FIG. 10 illustrates the case where the second sensor 38 is moved relative to the print medium M supported on the platen 34 from the other side toward the one side in the X direction (−X direction), above the print medium M.

Assume that the second sensor 38 is at a sixth position where the print medium M is located in the entire region of the light reception region La3 of the third light receiving part 326. In this case, the output voltage VC of the third light receiving part 326 takes a maximum value, and the output signal Vout based on this output voltage VC takes a minimum value.

In the case where the second sensor 38 is moved from the other side toward the one side in the X direction from the sixth position, the second sensor 38 transitions to a seventh position where the platen 34 is located in part of the light reception region La3 of the third light receiving part 326. At the seventh position, the amount of light received in the third light receiving part 326 decreases depending on a proportion of the light reception region La3 occupied by the platen 34. Accordingly, at the seventh position, the output voltage VC of the third light receiving part 326 gradually decreases with the movement. The output signal Vout thereby gradually increases in response to the change in the output voltage VC.

Then, in the case where the second sensor 38 is further moved from the other side toward the one side in the X direction from the seventh position, the second sensor 38 transitions to an eighth position where the platen 34 is located in the entire region of the light reception region La3 of the third light receiving part 326. At the eighth position, almost no light is reflected from the light reception region La3, and the amount of light received in the third light receiving part 326 is minimized. Accordingly, at the eighth position, the output voltage VC of the third light receiving part 326 takes a minimum value, and the output signal Vout based on the output voltage VC takes a maximum value.

Then, a position P3 where the output signal Vout of the single amplifier 334 passes a second threshold Th2 set in advance is detected for such changes in the output signal Vout based on the output voltage VC of the third light receiving part 326, and this position P3 is obtained as the end portion position of the print medium M. Note that, for example, the second threshold Th2 as described above is determined through experiments depending on the type and the like of the print medium M to be used.

### Printing Process

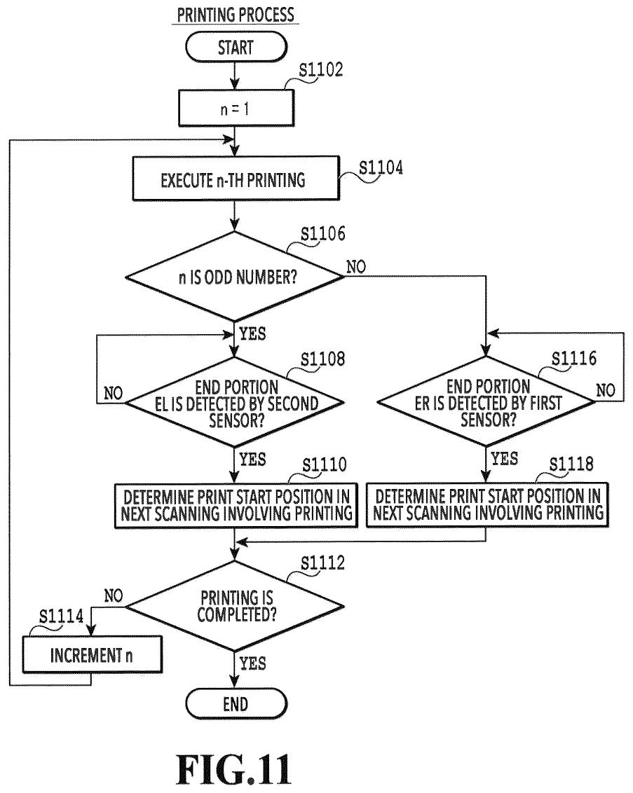

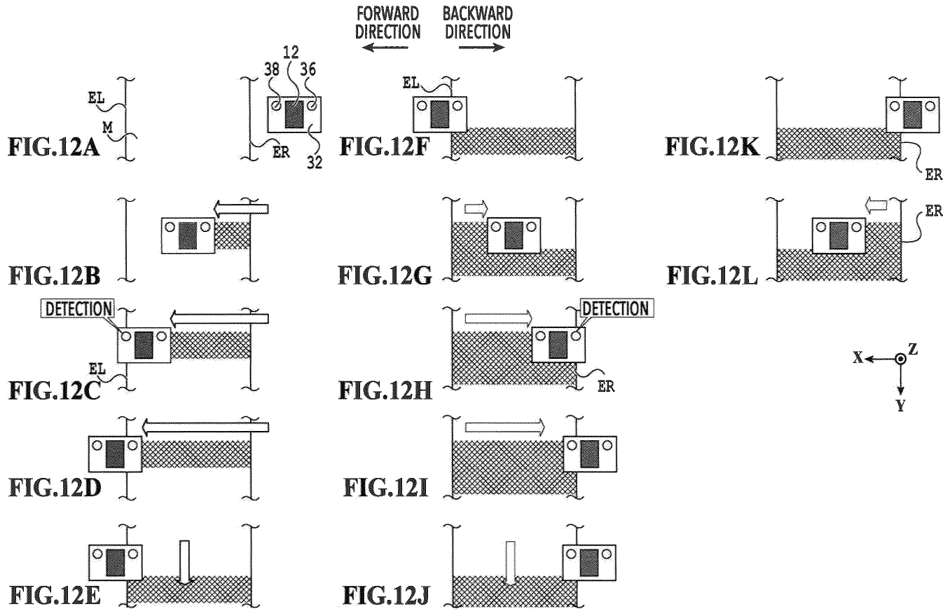

In the above-mentioned configuration, the printing apparatus 10 executes a printing process in which printing is performed on the print medium M based on a print job. FIG. 11 is a flowchart illustrating details of the printing process. FIGS. 12A to 12L are diagrams illustrating the positions of the first sensor 36 and the second sensor 38 relative to the print medium Mat each of timings in the printing process. The main controller 400 performs a series of processes illustrated in the flowchart of FIG. 11 by expanding program codes stored in the flash ROM 402 on the RAM 404 and executing the program codes. Alternatively, some or all of functions of steps in FIG. 11 may be executed by hardware such as an ASIC or an electric circuit. In the present specification, sign S in explanation of each process in the flowchart means step in this flowchart.

In the following explanation, a case where the printing apparatus 10 performs bidirectional printing in a forward direction (+X direction) from the one side toward the other side in the X direction and a backward direction (−X direction) from the other side toward the one side in the X direction is explained as an example. Moreover, the printing apparatus 10 repeatedly executes scanning involving printing by the print head 12 multiple times to print an image based on the print data on the print medium M. In the present embodiment, the main controller 400 functions as a print control part configured to control bidirectional printing by the printing part 30 in the forward direction and the backward direction.

In the case where the printing process is started, first, in S1102, the main controller 400 sets a variable n indicating the number of times of scanning involving printing by the print head 12 to “l”. Next, in S1104, the main controller 400 performs n-th scanning involving printing. Specifically, in the case where the variable n is 1, the print head 12 at the standby position (see FIG. 12A) performs printing by ejecting the ink to the print medium M while moving in the forward direction (see FIG. 12B). Moreover, in the case where the variable n is an even number, the print head 12 at a stop position on the other side in the X direction (see FIG. 12F) performs printing by ejecting the ink to the print medium M while moving in the backward direction (see FIG. 12G). Furthermore, in the case where the variable n is an odd number other than 11111, the print head 12 at a stop position on the one side in the X direction (see FIG. 12K) performs printing by ejecting the ink to the print medium M while moving in the forward direction (see FIG. 12L).

A printing start position in the X direction in the scanning involving printing is a position set in S1110 in the scanning performed via and immediately after S1108 to S1110 to be described later, and is a position set in S1118 in the scanning performed via and immediately after execution of S1116 to S1118 to be described later. Note that, in the case where the variable n is “l”, that is in the first scanning involving printing, a position set in advance may be set as the printing start position in the X direction. Alternatively, the configuration may be such that scanning of the carriage 32 is performed before the first scanning involving printing to cause the first sensor 36 or the second sensor 38 to detect a position of an end portion ER of the print medium Mon the one side, and the printing start position in the X direction in the first scanning involving printing is set based on a result of the detection.

In the case where the n-th scanning involving printing is started, in S1106, the main controller 400 determines whether the variable n is an odd number or not. In this case, in the printing apparatus 10, the print head 12 is moved in the forward direction from the one side toward the other side in the X direction in an odd-number scanning involving printing, and is moved in the backward direction from the other side toward the one side in the X direction in an even-number scanning involving printing.

Accordingly, in the odd-number scanning involving printing in which the print head 12 is moved in the forward direction, the second sensor 38 can detect an end portion EL of the print medium M on the other side in the X direction before the first sensor 36 (see FIG. 12C). Moreover, in the odd-number scanning involving printing, detecting the end portion EL by using the second sensor 38 can reduce a movement distance of the print head 12 in the forward direction from that in the case where the first sensor 36 is used (see FIG. 12D).

Meanwhile, in the even-number scanning involving printing in which the print head 12 is moved in the backward direction, the first sensor 36 can detect the end portion ER of the print medium on the one side in the X direction before the second sensor 38 (see FIG. 12H). Moreover, in the even-number scanning involving printing, detecting the end portion ER by using the first sensor 36 can reduce a movement distance of the print head 12 in the backward direction from that in the case where the second sensor 38 is used (see FIG. 12I).

If the variable n is determined to be an odd-number in S1106, the processing proceeds to S1108, and the main controller 400 determines whether the end portion EL of the print medium Mon the other side is detected by the second sensor 38. The detection of the end portion position of the print medium M by the second sensor 38 is executed based on the setting of the differential mode or the single mode. In the case of the differential mode, coordinates of two points where the differential signal Vout of the differential amplifier 332 passes the first threshold Th1 with the movement in the scanning direction are obtained, and the midpoint PO between these two points is detected as the end portion position of the print medium M. In the case of the single mode, a point where the output signal Vout of the single amplifier 334 passes the second threshold Th2 with the movement in the scanning direction is detected as the end portion position of the print medium M. As described above, in the present embodiment, the main controller 400 (position coordinate obtaining part 418 and calculation part 420) functions as an obtaining part configured to detect the end portion of the print medium M in the X direction and obtain the position of this end portion.

If the main controller 400 determines that the end portion EL of the print medium M is detected by the second sensor 38 in S1108 (see FIG. 12C), the process proceeds to S1110, and the main controller 400 sets the position of the detected end portion EL as the printing start position in the X direction in the next scanning involving printing. As described above, in the present embodiment, the main controller 400 functions as a determination part configured to determine the printing start position in the next scanning involving printing.

In the case where the n-th scanning involving printing is completed, the carriage 32 stops at a downstream stop position in the movement direction of this scanning (see FIGS. 12D and 12I). Thereafter, the printing apparatus 10 conveys the print medium M by a predetermined amount with the conveyance mechanism (see FIGS. 12E and 12J), and stands by until execution of the next scanning involving printing.

Then, in S1112, the main controller 400 determines whether the printing based on the print job is completed or not. If the main controller 400 determines that the printing based on the print job is completed in S1112, this printing process is terminated. Meanwhile, in the case where the main controller 400 determines that the printing based on the print job is not completed in S1112, the process proceeds to S1114, the main controller 400 increments the variable n, and the process returns to S1104.

Moreover, if the main controller 400 determines that the variable n is an even number in S1106, the process proceeds to S1116, and the main controller 400 determines whether the end portion ER of the print medium M on the one side is detected by the first sensor 36 or not. In the first sensor 36, a point where the output voltage of the light receiving part 304 in the first sensor 36 passes the threshold with the movement in the scanning direction is detected as the end portion position of the print medium M. If the main controller 400 determines that the end portion ER of the print medium M is detected by the first sensor 36 in S1116 (see FIG. 12H), the process proceeds to S1118. In S1118, the main controller 400 sets the position of the detected end portion ER as the printing start position in the X direction in the next scanning involving printing, and the process proceeds to S1112.

### Modification

Note that, although the case where the printing apparatus 10 executes the bidirectional printing of performing printing in the movement in the forward direction and the backward direction in the X direction in the printing process is explained above, the technique of the present disclosure is not limited to the printing apparatus that executes the bidirectional printing. The technique according to the present disclosure can be applied also to a printing apparatus that executes single-direction printing of performing printing in the movement in the forward direction or the backward direction in the X direction.

In this case, for example, in a form in which the printing is performed in the movement of the print head 12 in the forward direction, the position of the end portion ER of the print medium M on the one side corresponds to the printing start position. Accordingly, the processes of S1116 and S1118 are executed in the case where the scanning involving printing is completed and the print head 12 is moved to the start position for starting the next scanning involving printing. Moreover, for example, in a form in which the printing is performed in the movement of the print head 12 in the backward direction, the position of the end portion EL of the print medium Mon the other side corresponds to the printing start position. Accordingly, the processes of S1108 and S1110 are executed in the case where the scanning involving printing is completed and the print head 12 is moved to the start position for starting the next scanning involving printing.

Although the sensor that detects the end portion position of the print medium M is determined based on the number of times of scanning involving printing by the print head 12 in the printing process in the above-mentioned explanation, the present disclosure is not limited to this. For example, the sensor that detects the end portion position may be determined based on the direction in which the scanning by the print head 12 is performed. Specifically, the second sensor 38 detects the end portion EL of the print medium Min the case where the print head 12 is moved in the forward direction, and the first sensor 36 detects the end portion ER of the print medium Min the case where the print head 12 is moved in the backward direction.

In the above-mentioned explanation, the second sensor 38 is used to detect the end portion EL of the print medium M on the other side in the X direction. Although not particularly described in the above-mentioned explanation, the present disclosure is not limited to this. For example, the second sensor 38 may be used for detection of the end portion ER of the print medium M on the one side in the X direction, detection of passing of the print medium on the platen, detection of a leading edge portion of the print medium M in the conveyance direction, and the like. Moreover, although the first sensor 36 is used to detect the end portion ER of the print medium Mon the one side in the X direction, the present disclosure is not limited to this. For example, the first sensor 36 may be used for operations such as registration adjustment in which drop positions of ejected ink droplets are adjusted.

Although the first sensor 36 is provided on the one side of the carriage 32 in the X direction and the second sensor 38 is provided on the other side of the carriage 32 in the X direction in the above-mentioned explanation, the present disclosure is not limited to this. The configuration may be such that the first sensor 36 is provided on the other side of the carriage 32 in the X direction and the second sensor 38 is provided on the one side of the carriage 32 in the X direction. Moreover, the configuration may be such that no first sensor 36 is provided, and the second sensors 38 are provided on the one side and the other side of the carriage 32 in the X direction.

Although the second sensor 38 includes the third light receiving part 326 in the above-mentioned explanation, the second sensor 38 may have a configuration including no third light receiving part 326. Moreover, configurations of the position coordinate obtaining part 418, the calculation part 420, and the like that obtain the end portion positions of the print medium M based on the output values from the output switching amplifier 330, the first sensor 36, and the second sensor 38 may be such that these parts are provided in an external apparatus connected to the printing apparatus 10. Moreover, although the end portion EL is detected by using the second sensor 38 in S1108 and the end portion ER is detected by using the first sensor 36 in S1116 in the above mentioned explanation, the present disclosure is not limited to this. The differential mode of the second sensor 38 may be used for the detection of the end portion EL in S1108 and the detection of the end portion ER in S1116.

### Operations and Effects

As explained above, the printing apparatus 10 according to the present embodiment includes the first sensor 36 on the one side in the movement direction of the carriage 32 in which the print head 12 is mounted, and is provided with the second sensor 38 on the other side in the movement direction. Moreover, the first sensor 36 or the second sensor 38 obtains the end portion position of the print medium Min the scanning involving printing by the print head 12. Then, the printing start position in the movement direction of the scanning in the next scanning involving printing is determined based on the obtained end portion position.

This reduces a scanning range of the print head 12 (carriage 32) in the print scanning, and can contribute to downsizing of the printing apparatus 10 and reduction of a time period required for the printing process. Moreover, in the scanning involving printing, the printing start position in the next scanning involving printing is obtained. Accordingly, a margin is less likely to be formed in the case where marginless printing is performed, and for example, printing can be performed very close to the end portions EL and ER of the print medium Min the scanning direction. Accordingly, it is possible to execute micro-margin printing in which very fine margins are formed in the end portion portions EL and ER and visual effects equivalent to marginless printing can be obtained. In this case, there is no need to install, for example, an absorber or the like in the platen 34, and a configuration around the platen 34 can be simplified.

### Second Embodiment

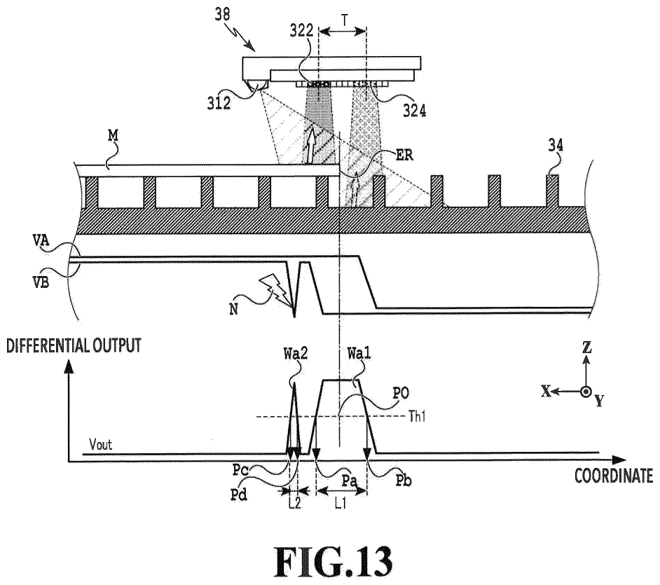

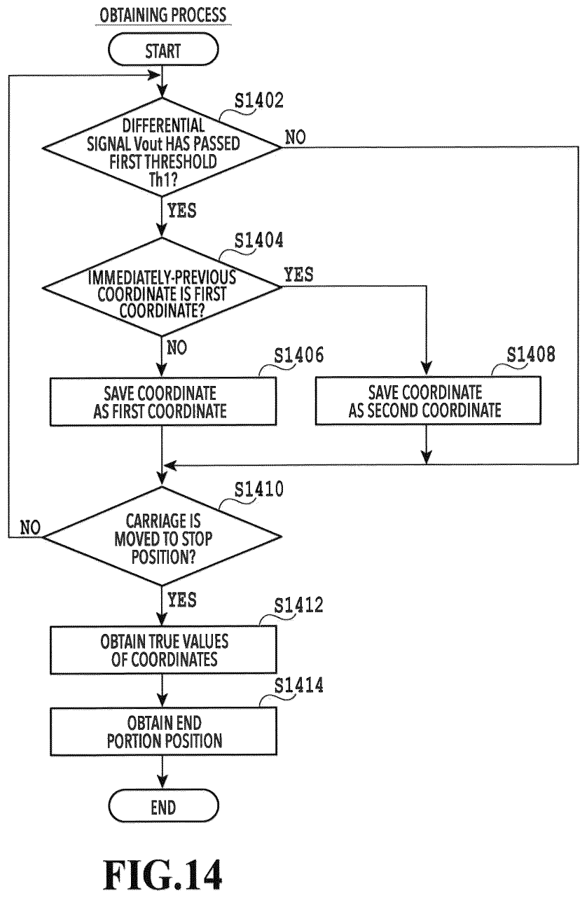

Next, a printing apparatus according to a second embodiment is explained with reference to FIGS. 13 and 14. In the following explanation, configurations identical or corresponding to the configurations of the printing apparatus according to the first embodiment described above are denoted by the same reference numerals as the reference numerals used in the first embodiment, and detailed explanation thereof is omitted.

As described above, the printing apparatus is configured such that, in the differential mode, the second sensor 38 receives the reflected light of the light emitted from the light emitting part 312 in the first light receiving part 322 and the second light receiving part 324, and outputs the voltages corresponding to the amount of received light. Accordingly, a pulse with a very small width is sometimes formed in the outputted waveform of the differential amplifier 332 by fluctuation or noise in the sensor signals. In the case where such a pulse has an intensity exceeding the first threshold Th1, four or more points where the output voltage passes the first threshold Th1 are formed, and there is a possibility that the end portion of the print medium M in the X direction cannot be accurately detected.

In the second embodiment, the end portion position of the print medium in the X direction can be accurately obtained also in the case where a pulse formed by fluctuation, noise, or the like in the sensor signals as described above is generated at an intensity exceeding the first threshold Th1. Specifically, two coordinates in a pair of coordinates in which a distance between the two coordinates is closest to a theoretical value among pairs of coordinates at which the output voltage has passed the first threshold Th1 in the rising and dropping of the output waveform are set as true values, and these true values are used to obtain the end portion position of the print medium in the X direction.

### Outline of Obtaining of End Portion Position of Print Medium

First, an outline of obtaining of the end portion position of the print medium in the X direction in the printing apparatus 10 according to the present embodiment is explained. FIG. 13 is a diagram explaining the outline of obtaining of the end portion position of the print medium in the printing apparatus 10 according to the present embodiment. Note that, in FIG. 13, the light emitting part 312 is arranged at a position away from the light receiving member 314 in the X direction to facilitate understanding. Moreover, FIG. 13 illustrates that a gap is provided between the output waveform of the output voltage VA and the output waveform of the output voltage VB in a portion where the output voltages are the same to facilitate understanding.

Assume that, in the case where the second sensor 38 passes the end portion ER of the print medium Mon one side from above the print medium M and moves to a position above the platen 34, the output voltage VB is affected by noise N before passing of the end portion ER by the second light receiving part 324, and decreases. In this case, in the output waveform based on the output signal Vout of the differential amplifier 332, a waveform Wa2 formed by the effect of the noise N is formed near a waveform Wa1 formed near the end portion ER.

The position coordinate obtaining part 418 obtains a first coordinate at which the output signal Vout exceeds the first threshold Th1 and a second coordinate at which the output signal Vout falls below the first threshold Th1 for each of the waveform Wa1 and the waveform Wa2. Specifically, a first coordinate Pa and a second coordinate Pb are obtained for the waveform Wa1 and a first coordinate Pc and a second coordinate Pd are obtained for the waveform Wa2. Then, the position coordinate obtaining part 418 obtains distances L between the first coordinates and the second coordinates, compares each of the distances L with a theoretical value T, and sets the first coordinate and the second coordinate corresponding to the distance L closest to the theoretical value T as the true values. Note that, in the present embodiment, the theoretical value Tis a distance between a center position of the first light receiving part 322 and a center position of the second light receiving part 324 in the X direction. Then, the calculation part 420 obtains the midpoint PO of the first coordinate and the second coordinate set as the true values as the end portion ER of the print medium M.

In the present embodiment, since the distance L1 between the first coordinate Pa and the second coordinate Pb of the waveform Wa1 is closer to the theoretical value T than the distance L2 between the first coordinate Pc and the second coordinate Pd of the waveform Wa is, the first coordinate Pa and the second coordinate Pb are set as the true values. Then, the end portion ER is obtained based on the first coordinate Pa and the second coordinate Pb set as the true values. Note that the method of obtaining the end portion position of the print medium M is not limited to this. For example, the first coordinate or the second coordinate set as the true value may be determined as the end portion position. Alternatively, a position obtained by adding or subtracting an offset distance based on the theoretical value to or from the first coordinate or the second coordinate set as the true value may be determined as the end portion position.

### Obtaining Process

Next, an obtaining process of the end portion of the print medium M based on the differential signal Vout of the differential amplifier 332 in the differential mode is explained. Note that the obtaining process explained below is started after the start of the n-th scanning involving printing in S1104 in the above-mentioned printing process, and is executed in, for example, S1108. FIG. 14 is a flowchart illustrating details of the obtaining process in which the end portion of the print medium M is obtained based on the differential signal Vout. The main controller 400 performs a series of processes illustrated in the flowchart of FIG. 14 by expanding program codes stored in the flash ROM 402 on the RAM 404 and executing the program codes. Alternatively, some or all of functions of steps in FIG. 14 may be executed by hardware such as an ASIC or an electric circuit.

In the case where the obtaining process is started, first, in S1402, the main controller 400 determines whether the obtained differential signal Vout of the differential amplifier 332 has passed the first threshold Th1 or not. Specifically, in the case where the scanning involving printing by the print head 12 is started, the main controller 400 starts monitoring of the differential signal Vout of the differential amplifier 332. Accordingly, in S1402, the main controller 400 determines whether the differential signal Vout has exceeded the first threshold Th1 or not in the case where the differential signal Vout is rising, and determines whether the differential signal Vout has fallen below the first threshold Th1 or not in the case where the differential signal Vout is dropping. Specifically, if the main controller 400 determines that the differential signal Vout has exceeded or fallen below the first threshold Th1 in S1402, the main controller 400 determines that the differential signal Vout has passed the first threshold Th1. Meanwhile, if the main controller 400 determines that the differential signal Vout has not exceeded or fallen below the first threshold Th1, the main controller 400 determines that the differential signal Vout has not passed the first threshold Th1. Note that, if the main controller 400 determines that the differential signal Vout has passed the first threshold Th1 in Sl402, the main controller 400 obtains a coordinate value at which this determination is made, that is a coordinate value at which the differential signal Vout has reached the first threshold Th1.

If the main controller 400 determines that the differential signal Vout has not passed the first threshold Th1 in S1402, the process proceeds to S1410 to be described later. Meanwhile, if the main controller 400 determines that the differential signal Vout has passed the first threshold Th1 in S1402, the process proceeds to S1404, and the main controller 400 determines whether the immediately-previous obtained coordinate is the first coordinate or not. If the main controller 400 determines that the immediately-previous obtained coordinate is not the first coordinate in S1404, the process proceeds to S1406, and the main controller 400 holds the coordinate obtained in S1402 as the first coordinate, and proceeds to S1410. Meanwhile, if the main controller 400 determines that the immediately-previous obtained coordinate is the first coordinate in S1404, the process proceeds to S1408, the main controller 400 holds the coordinate obtained in S1402 as the second coordinate, and the process proceeds to S1410. Note that, in S1408, the held second coordinate is associated with the immediately-previous obtained first coordinate.

In S1410, the main controller 400 determines whether the carriage 32 is moved to the stop position or not. Note that the stop position is stored in advance in a storage region of the printing apparatus 10. If the main controller 400 determines that the carriage 32 is not moved to the stop position in S1410, the process returns to S1402. Meanwhile, if the main controller 400 determines that the carriage 32 is moved to the stop position in S1410, the process proceeds to S1412, and the main controller 400 obtains the true values of the coordinates.

In S1412, the distance between the two coordinates of the first coordinate and the second coordinate associated with each other is obtained, and the first coordinate and the second coordinate corresponding to the obtained distance closest to the theoretical value T are obtained as the true values of the coordinates. The theoretical value T is stored in advance in the storage region. Note that, in the case where there is only one pair of the first coordinate and the second coordinate associated with each other, these coordinates are obtained as the true values of the coordinates. Then, in S1414, the main controller 400 obtains the end portion of the print medium M based on the first coordinate and the second coordinate set as the true values, and terminates this obtaining process. Specifically, in S1414, the midpoint PO of the first coordinate and the second coordinate set as the true values is obtained as the end portion of the print medium M in the X direction.

### Modification

In the above-mentioned explanation, the obtained first coordinates and the second coordinates are all held, and then the true values of the coordinates are obtained. However, the present disclosure is not limited to this. For example, the configuration may be as follows. The distance between the first coordinate and the second coordinate associated with each other is obtained after the obtaining of the second coordinate, and in the case where a difference between the obtained distance and the theoretical value Tis larger than a predetermined value, the first coordinate and the second coordinate are determined as abnormal values and not held in the storage region. Specifically, in this case, a midpoint between two points where the above-mentioned difference is equal to or smaller than the predetermined value is obtained as the end portion of the print medium M, and is held in the storage region. Note that the predetermined value is, for example, 20% of the theoretical value T. This reduces a use amount of the storage region in the case where the obtaining process is executed.

### Operations and Effects

As explained above, in the present embodiment, the distance between the two obtained coordinates of the first coordinate and the second coordinate is compared with the theoretical value based on the distance between the first light receiving part 322 and the second light receiving part 324. Then, the two coordinates corresponding to the distance close to the theoretical value are set as the true values of the first coordinate and the second coordinate, and the end portion of the print medium M is obtained by using these true values. Even if fluctuation or noise occurs in the output signals from the light receiving parts, this configuration can eliminate a waveform caused by the fluctuation or the noise in the output waveform of the differential signal Vout, and enables accurate detection of the end portion of the print medium M.

### Third Embodiment

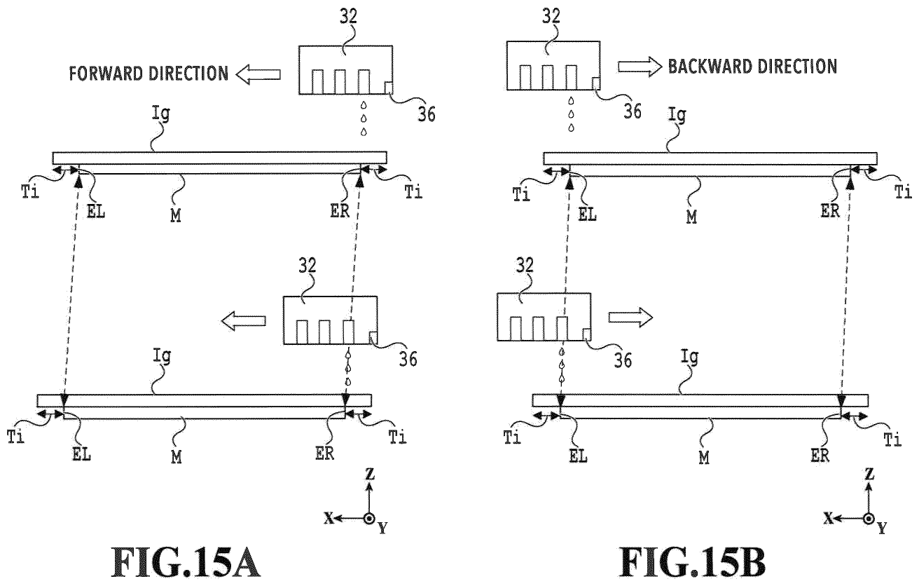

Next, a printing apparatus according to a third embodiment is explained with reference to FIGS. 15A to 19. In the following explanation, configurations identical or corresponding to the configurations of the printing apparatus according to the first embodiment described above are denoted by the same reference numerals as the reference numerals used in the first embodiment, and detailed explanation thereof is omitted.

The first sensor 36 has a simpler configuration than the second sensor 38, and is thus less expensive than the second sensor 38. However, since the first sensor 36 performs detection based on the output voltage from one light receiving part, the first sensor 36 is more likely to be affected by, for example, the movement speed of the carriage. Moreover, in the printing apparatus 10, the movement speed of the carriage 32 provided with the first sensor 36 changes depending on a print mode, an image pattern, and the like. Accordingly, there is a possibility that the detection accuracy of the first sensor 36 varies.

The third embodiment is different from the above-mentioned first embodiment in that changes in the movement speed of the first sensor 36 in the detection of the end portion of the print medium M are suppressed to suppress variations in the detection accuracy of the first sensor 36. In the following explanation, “the movement speed of the first sensor 36 in the detection (passing) of the end portion of the print medium M” means the speed of the first sensor 36 moved via the carriage 32 in the detection (passing) of the end portion of the print medium M. In other words, “the movement speed of the first sensor 36 in the detection (passing) of the end portion of the print medium M” means the movement speed of the carriage 32 in the detection (passing) of the end portion of the print medium M by the first sensor 36.

### Micro-Margin Printing

Next, explanation is given of the size of a print image and the printing start position in the X direction in execution of micro-margin printing in which visual effects similar to marginless printing can be obtained. FIGS. 15A and 15B are diagrams illustrating the size of the print image relative to the print medium M and the printing start position in the X direction in the micro-margin printing. FIG. 15A illustrates the printing start position in the case where the carriage 32 is moved (performs scanning) in the forward direction, and FIG. 15B illustrates the printing start position in the case where the carriage 32 is moved in the backward direction. Note that, in FIGS. 15A and 15B, illustration of the second sensor 38 is omitted to facilitate understanding.

The end portion position of the print medium M in the X direction sometimes deviates due to skewing of the print medium M caused by the conveyance and stretching of the print medium M from a nominal value due to humidity or the like. Accordingly, in the micro-margin printing in which an image is printed very close to the edges of the print medium M, for example, the print image Ig is generated by being enlarged such that the print image Ig is larger than the print medium M by a predetermined amount Ti in the X direction. Then, timings of ink ejection from each nozzle array are adjusted, and the printing is performed from positions very close to the end portions EL and ER of the print medium M. Note that the user can select whether to execute the micro-margin printing or not. Note that, for example, the immediately-previous obtained position information is used for the end portions EL and ER.

### Movement Speed of First Sensor

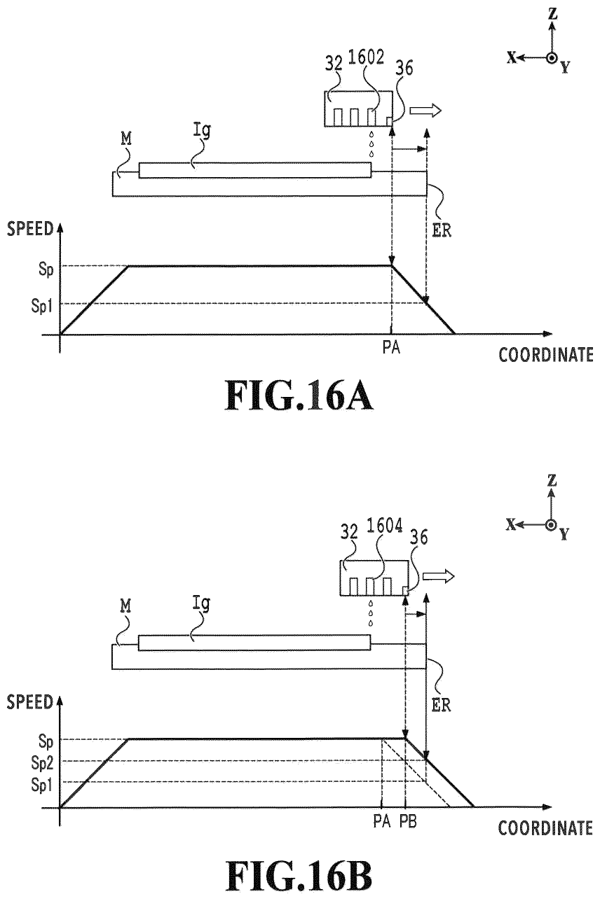

Next, changes in the movement speed of the first sensor 36 in the scanning involving printing is explained. FIGS. 16A and 16B are diagrams explaining the changes in the movement speed of the first sensor 36 in the scanning involving printing, depending on differences in the nozzle array ejecting the ink. FIG. 16A is a diagram illustrating the change in the movement speed of the first sensor 36 in the case where the ink is ejected from the nozzle array located most downstream in the movement direction of the carriage 32. FIG. 16B is a diagram illustrating the change in the movement speed of the first sensor 36 in the case where the ink is ejected from the nozzle array located upstream, in the movement direction, of the nozzle array ejecting the ink in FIG. 16A.

In the case where the print image Ig is printed on the print medium M, the movement speed of the carriage 32 reaches a predetermined speed Sp before the printing of the print image Ig, maintained at the predetermined speed Sp during the printing of the print image Ig, and decreases from the predetermined speed SP after the printing of the print image Ig.

Specifically, in the scanning involving printing in the backward direction (−X direction), the carriage 32 starts moving from the stop position on the other side in the X direction, and the movement speed of the carriage 32 gradually increases and reaches the set predetermined speed Sp at a timing of the start of the printing of the print image Ig. Next, the movement speed of the carriage 32 is maintained at the predetermined speed Sp during the printing of the print image Ig. Then, the movement speed of the carriage 32 decreases at a timing of the end of the printing of the print image Ig, and gradually decreases until the carriage 32 stops at the stop position on the one side in the X direction.

Since the first sensor 36 is provided in the carriage 32, the first sensor 36 is moved at the same movement speed as the carriage 32. Note that, in the carriage 32, the first sensor 36 is located downstream of the nozzle arrays of the print head 12 in the backward direction. However, in the case where the first sensor 36 is upstream, in the movement direction, of the end portion ER of the print medium M in the X direction at the timing of the end of the printing of the print image Ig, the first sensor 36 decelerates before the detection of the end portion ER (see FIG. 16A).

Moreover, the closer the nozzle array ejecting the ink in the printing of the print image Ig is to the first sensor 36 in the X direction, the earlier the deceleration of the first sensor 36 is started. For example, in the case where the print image Ig is printed by a nozzle array 1602 located most downstream in the backward direction in the print head 12, the first sensor 36 starts to decelerate from a coordinate PA (see FIG. 16A). Meanwhile, in the case where the print image Ig is printed by a nozzle array 1604 located upstream of the nozzle array 1602 in the backward direction in the print head 12, the first sensor 36 starts to decelerate from a coordinate PB located downstream of the coordinate PA in the backward direction (see FIG. 16B). Accordingly, a movement speed Spl of the first sensor 36 in the passing of the end portion ER in the deceleration from the coordinate PA is lower than a movement speed Sp2 of the first sensor 36 in the passing of the end portion ER in the deceleration from the coordinate PB. As described above, the movement speed of the first sensor 36 in the passing of the end portion of the print medium M varies depending on the position, in the X direction, of the nozzle array performing printing of the end portion position of the print medium M.

As described above, the detection of the end portion position of the print medium M by the first sensor 36 is based on the value corresponding to the amount of light received in the light receiving part 304 in the movement of the carriage 32. Accordingly, if the movement speed of the first sensor 36 in the passing of the end portion ER changes before reaching the end portion ER, the coordinate at which the output voltage reaches the threshold (see FIG. 6) varies more than that in the case where the movement speed does not change. The detected end portion position thereby deviates from the end portion position in the case where the movement speed does not change.

### Change of Stop Position

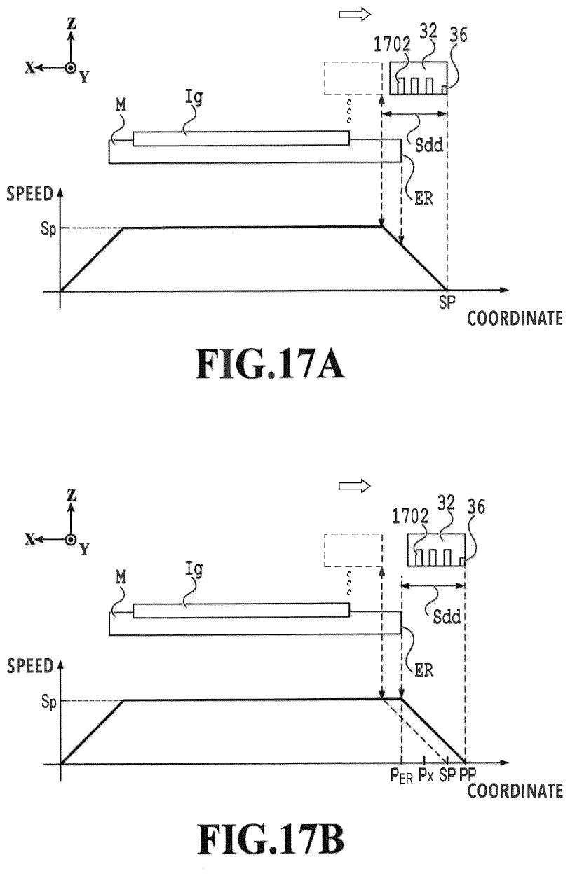

Accordingly, in the present embodiment, the stop position of the carriage 32 in the scanning involving printing for detection of the end portion of the print medium M is changed such that the movement speed of the first sensor 36 in the passing of the end portion is not reduced from the movement speed in the printing of the print image Ig. Specifically, the stop position of the carriage 32 in the scanning is shifted downstream in the movement direction in the scanning. The outline of the change of the stop position is explained below with reference to FIGS. 17A and 17B. FIGS. 17A and 17B are diagrams explaining an outline of the change of the stop position of the carriage 32.

The print image Ig is assumed to be printed by ejecting the ink from a nozzle array 1702 of the print head 12 to the print medium M. In this case, the stop position of the carriage 32 is changed to a predetermined position PP (see FIG. 17B) downstream of a set stop position SP (see FIG. 17A) in the movement direction of the carriage 32.

Specifically, the predetermined position PP is a position that is downstream of a position PER corresponding to the end portion ER of the print medium M in the movement direction of the carriage 32 and that is away from the position PER by a deceleration distance Sdd of the carriage 32. Note that the deceleration distance Sdd of the carriage 32 is a distance over which the carriage 32 travels from the start of the deceleration to the stop or a distance longer than this distance by a fixed amount. The movement speed in the case where the first sensor 36 passes the end portion ER of the print medium M is thereby not reduced from the predetermined speed Sp in the printing of the print image Ig.

Note that the predetermined position PP only needs to be a position that is at least downstream of and away from the position PER by the deceleration distance Sdd in the movement direction of the carriage 32. Accordingly, the predetermined position PP may be, for example, a position downstream of and away from a position Px (FIG. 17B) by the deceleration distance Sdd in the movement direction of the carriage 32, the position Px being downstream of the position PER in the movement direction. Moreover, the deceleration distance Sdd may be determined through experiments depending on, for example, the movement speed of the carriage 32 and the like.

### Changing Process

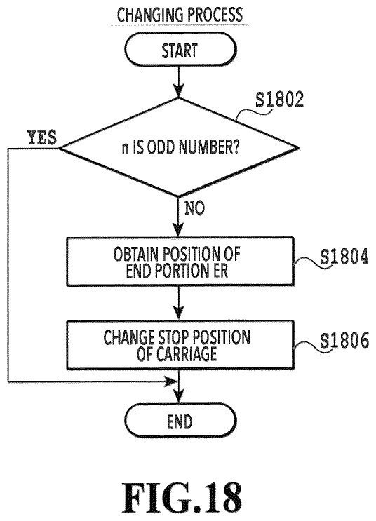

Next, a changing process of changing the stop position of the carriage 32 is explained. FIG. 18 is a flowchart illustrating details of the changing process of changing the stop position of the carriage 32. The main controller 400 performs a series of processes illustrated in the flowchart of FIG. 18 by expanding program codes stored in the flash ROM 402 on the RAM 404, and executing the program codes. Alternatively, some or all of functions of steps in FIG. 18 may be executed by hardware such as an ASIC or an electric circuit.

The changing process of FIG. 18 is executed immediately before the process of S1104 in the printing process (see FIG. 11) in the case where the micro-margin printing is executed in the bidirectional printing. Specifically, the changing process is executed for each operation of the scanning involving printing, immediately before execution of this scanning. Note that the changing process is not executed in the case where the executed printing is not the micro-margin printing.

In the case where the changing process is started, first, in S1802, the main controller 400 determines whether the variable n indicating the number of times of execution of the scanning involving printing is an odd number or not. In the present embodiment, the first sensor 36 is provided on the one side of the carriage 32, and the second sensor 38 is provided on the other side of the carriage 32. In the second sensor 38, the end portion EL of the print medium M can be accurately obtained irrespective of the movement speed of the carriage, by using the differential signal based on the output signals from the first light receiving part 322 and the second light receiving part 324. Accordingly, in the scanning involving printing in the forward direction in which the end portion EL of the print medium M is detected by using the second sensor 38, there is no need to change the stop position of the carriage 32.

Accordingly, if the main controller 400 determines that the variable n is an odd number, the main controller 400 determines that the n-th scanning involving printing is the scanning involving printing in the forward direction in which the end portion EL of the print medium M is detected by using the second sensor 38, and terminates this changing process. Meanwhile, if the main controller 400 determines that the variable n is an even number, that is not an odd number in S1802, the main controller 400 determines that the n-th scanning involving printing is the scanning involving printing in the backward direction in which the end portion ER of the print medium M is detected by using the first sensor 36, and the process proceeds to S1804. In S1804, the main controller 400 obtains the position (coordinate) of the end portion ER. The obtained position of the end portion ER is the position information (coordinate information) obtained in the immediately-previous scanning involving printing in the backward direction.

Note that, in the case where the variable is “2”, no immediately-previous scanning involving printing in the backward direction is executed. Accordingly, for example, before the execution of the actual printing based on the print job, scanning of the carriage 32 in the backward direction is performed, and the position of the end portion ER of the print medium M is obtained in this scanning. Thus, in S1804, in the case where the variable n is “2”, the position information of the end portion ER obtained by this scanning executed before the printing is obtained.

Thereafter, in S1806, the main controller 400 changes the stop position of the carriage 32 in the n-th scanning involving printing based on the position of the end portion ER obtained in S1804 and the deceleration distance Sdd stored in advance, and terminates this changing processing. Specifically, in S1806, a position downstream of and away from the position of the end portion ER obtained in S1804 by the deceleration distance Sdd in the backward direction is determined as the stop position of the carriage 32 in the n-th scanning involving printing. In other words, in S1806, the coordinate information being the stop position of the carriage 32 is obtained by adding the deceleration distance Sdd to the coordinate information of the end portion ER in the X direction.

Note that the movement speed of the carriage 32 in the printing of the print image varies depending on the print mode and the like. Accordingly, in the printing apparatus 10, for example, the deceleration distance Sdd corresponding to each of the movement speeds of the carriage 32 in the respective print modes is held in the storage reg10n. Thus, the deceleration distance Sdd used in S1806 is determined based on the print mode and the like.

### Modification

As described above, the second sensor 38 is configured to be capable of detecting the end portion of the print medium M by using only the third light receiving part 326. Specifically, the second sensor 38 can function in a detection mode (single mode) in which a detection mechanism similar to the first sensor 36 is used. Accordingly, in this case, the stop position of the carriage 32 needs to be changed also in the scanning involving printing in the forward direction. The changing process in the case where the second sensor 38 functions in the single mode is explained below.

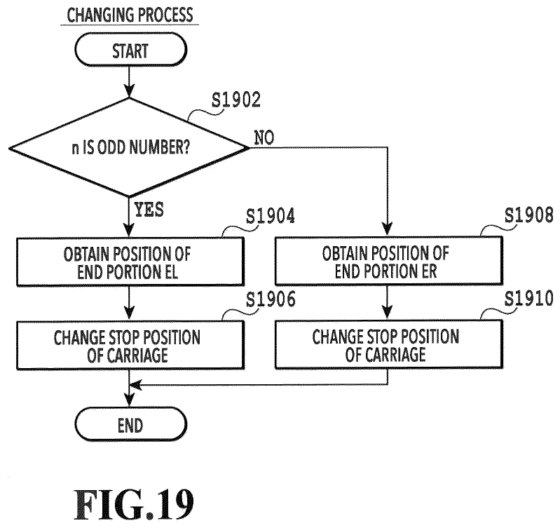

FIG. 19 is a flowchart illustrating details of the changing process in the case where the second sensor 38 functions in the single mode. The main controller 400 performs a series of processes illustrated in the flowchart of FIG. 19 by expanding program codes stored in the flash ROM 402 on the RAM 404 and executing the program codes. Alternatively, some or all of functions of steps in FIG. 19 may be executed by hardware such as an ASIC or an electric circuit.

In the case where the changing process of FIG. 19 is started, first, in S1902, the main controller 400 determines whether the variable n indicating the number of times of execution of the scanning involving printing is an odd-number or not. If the main controller 400 determines that the variable n is an odd number in S1902, the process proceeds to S1904, and the main controller 400 obtains the position (coordinate) of the end portion EL. The obtained position of the end portion EL is the position information (coordinate information) obtained in the immediately-previous scanning involving printing in the forward direction.

Note that, in the case where the variable n is “1” no immediately-previous scanning involving printing in the forward direction is executed. Accordingly, for example, before the execution of the actual printing based on the print job, scanning of the carriage 32 in the forward direction and the backward direction is performed, and the positions of the end portions EL and ER of the print medium M are obtained in this scanning. Thus, in the case where the variable n is “1”, the position information of the end portion EL obtained by this scanning performed before the printing is obtained.

Thereafter, in S1906, the main controller 400 changes the stop position of the carriage 32 in the n-th scanning involving printing based on the position of the end portion EL obtained in S1904 and the deceleration distance Sdd stored in advance, and terminates this changing processing. Specifically, in S1906, a position downstream of and away from the position of the end portion EL obtained in S1904 by the deceleration distance Sdd in the forward direction is determined as the stop position of the carriage in the n-th scanning involving printing. In other words, in S1906, the coordinate information being the stop position of the carriage 32 is obtained by adding the deceleration distance Sdd to the coordinate information of the end portion EL in the X direction.

Note that the movement speed of the carriage 32 in the printing of the print image varies depending on the print mode and the like. Accordingly, in the printing apparatus 10, for example, the deceleration distance Sdd corresponding to each of the movement speeds of the carriage 32 in the respective print modes is held in the storage reg10n. Thus, the deceleration distance Sdd used in S1906 and S1910 to be described later is determined based on the print mode and the like.

Meanwhile, if the main controller 400 determines that the variable n is not an odd number, that is an even number in S1902, the process proceeds to S1908, and the main controller 400 obtains the position (coordinate) of the end portion ER. The obtained position of the end portion ER is the position information (coordinate information) obtained in the immediately-previous scanning involving printing in the backward direction. Note that, in the case where the variable n is “2”, no immediately previous scanning involving printing in the backward direction is executed. Accordingly, in the case where the variable is “2”, the position information of the end portion ER obtained in the above-mentioned scanning executed before the printing is obtained.

Thereafter, in S1910, the main controller 400 changes the stop position of the carriage 32 in the n-th scanning involving printing based on the position of the end portion ER obtained in S1908 and the deceleration distance Sdd stored in advance, and terminates this changing processing. Specifically, in S1910, a position downstream of and away from the position of the end portion ER obtained in S1908 by the deceleration distance Sdd in the backward direction is determined as the stop position of the carriage 32 in the n-th scanning involving printing. In other words, in S1910, the coordinate information being the stop position of the carriage 32 is obtained by adding the deceleration distance Sdd to the coordinate information of the end portion ER in the X direction.

### Modification

In the above-mentioned explanation, in the scanning involving printing in the backward direction in which the first sensor 36 detects the end portion ER, the stop position of the carriage 32 is changed. However, the present disclosure is not limited to this. For example, the stop position of the carriage 32 may be changed in the case where the main controller 400 determines that the stop position needs to be changed, based on the size of the print image Ig, the position of the end portion of the print image Ig with respect to the end portion ER, the position of the nozzle array ejecting the ink in the X direction, and the like.

In the above-mentioned explanation, the changing of the stop position of the carriage 32 is executed in the detection of the end portion ER by the first sensor 36. However, the execution of the changing is not limited to this case. For example, the changing may be executed in the case where the end portion EL of the print medium M is detected in in the single mode of the second sensor 38.

### Operations and Effects

As explained above, in the present embodiment, the printing apparatus 10 changes the stop position of the carriage 32 in the scanning involving printing in which the end portion of the print medium M is detected by using the first sensor 36 whose detection accuracy varies depending on the change in the movement speed in the passing of the end portion. Specifically, the position downstream of and away from the position of the end portion by the deceleration distance Sdd in the scanning direction is set as the stop position of the carriage 32, the deceleration distance Sdd taking deceleration of the carriage 32 to the stop position into consideration. In the printing apparatus 10, the movement speed in the case where the first sensor 36 passes the end portion is thereby not reduced from the speed in the printing of the print image, and variation in the detection accuracy of the first sensor 36 is less likely to occur.

### Fourth Embodiment

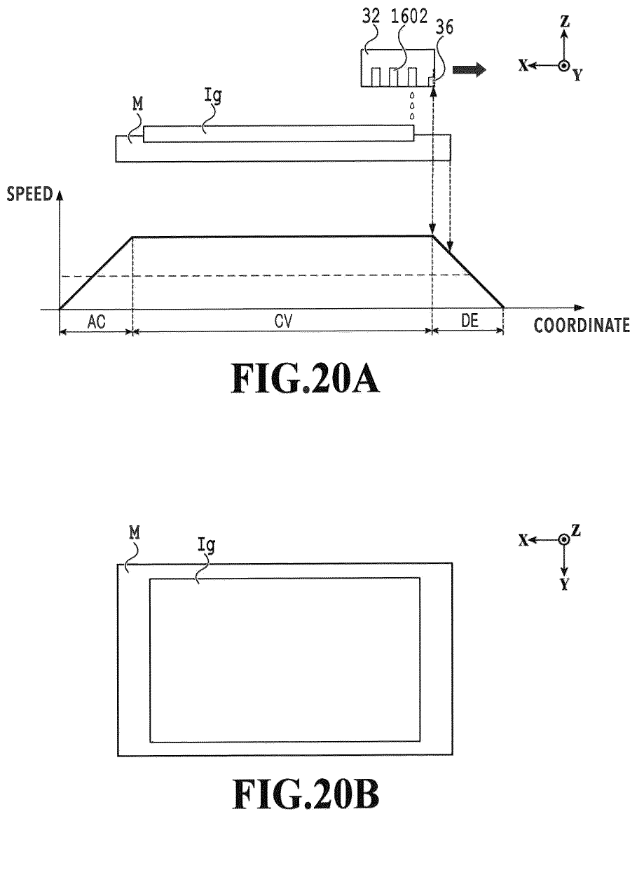

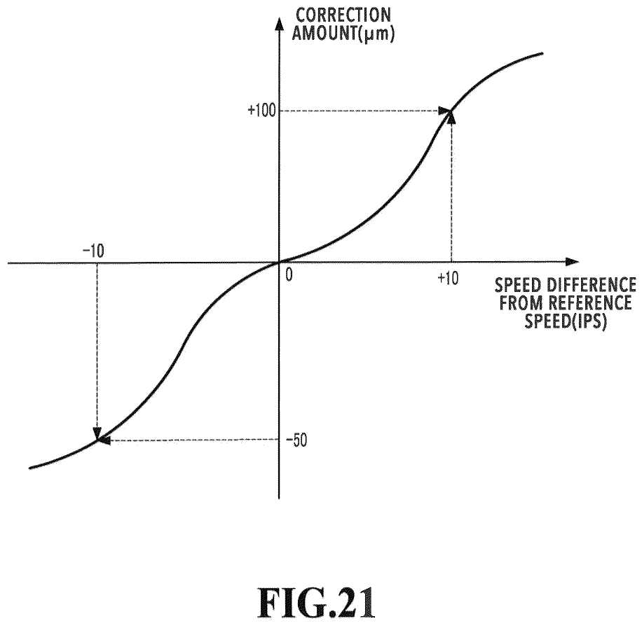

Next, a printing apparatus according to a fourth embodiment is explained with reference to FIGS. 20A to 21. In the following explanation, configurations identical or corresponding to the configurations of the printing apparatus according to the first embodiment described above are denoted by the same reference numerals as the reference numerals used in the first embodiment, and detailed explanation thereof is omitted.

The fourth embodiment is different from the above-mentioned third embodiment in that the detection result of the first sensor 36 is corrected to suppress variations in the detection accuracy of the first sensor 36 that are caused by the movement speed in the passing of the end portion of the print medium M.

As described above, in the printing apparatus 10, the scanning involving printing is repeatedly executed multiple times to print the print image Ig based on the print data. Accordingly, assuming that conditions are constant, no change occurs in the unit of scanning involving printing even in the case where the movement speed of the first sensor 36 in the passing of the end portion of the print medium M is reduced from the movement speed in the printing of the print image Ig. Specifically, the value of the speed of the first sensor 36 in the passing of the end portion of the print medium M is the same among operations of the scanning involving printing. The conditions include, for example, a condition that the nozzle array ejecting the ink is fixed (see FIG. 20A), a condition that the length of the print image Ig in the X direction is constant (see FIG. 20B), and the like.

Accordingly, in the present embodiment, the end portion position obtained based on the detection result of the first sensor 36 is corrected based on a speed difference between the movement speed in the printing of the print image Ig and the movement speed in the passing of the end portion of the print medium M. A correction method is explained below in detail.

The scanning speed (predetermined speed Sp described above) of the carriage 32 is determined depending on the print conditions such as the print mode. In the case where the scanning speed of the carriage 32 is determined, an acceleration region section AC, a constant velocity region section CV, and a deceleration region section DE (see FIG. 20A) are determined. Then, the movement speed of the first sensor 36 in the passing of the end portion of the print medium M can be obtained based on the size of the print medium M, the length of the print image Ig in the X direction, the print conditions such as the type of ink, and the above-mentioned deceleration region section DE.

Moreover, the printing apparatus 10 holds data indicating a relationship between: a difference between a reference speed and the movement speed of the first sensor 36 in the passing of the end portion of the print medium M; and an error in the obtained position of this end portion, in the flash ROM 402. In the printing apparatus 10, the movement speed of the carriage 32 in the printing is fixed, and this data is data that covers an entire range of this movement speed. Moreover, the reference speed may be any speed at which the carriage 32 can move.

Specifically, the held data is data indicating a correction amount by which the obtained end portion position is corrected for a difference between the movement speed in the constant velocity region section CV and the movement speed of the first sensor 36 in the passing of the end portion of the print medium M, with the movement speed in the section CV being a reference.

FIG. 21 illustrates an example of data indicating a relationship between the movement speed difference and the correction amount. In FIG. 21, the range of movement speed (scanning speed) at which the carriage 32 can move in the printing is 10 IPS (inch/sec) to 40 IPS, and the reference speed is 25 IPS.

In the case where the movement speed of the first sensor 36 obtained based on the various printing conditions is 35 IPS, the difference from the reference speed is “+10 (=35−25) IPS”, and the corresponding correction amount is “+100 μm” based on the data of FIG. 21. Accordingly, in this case, 100 μm is added to the position of the end portion of the print medium M obtained based on the detection result of the first sensor 36. Moreover, in the case where the movement speed of the first sensor 36 obtained based on the various print conditions is 15 IPS, the difference from the reference speed is “−10 (=15−25) JPS”, and the corresponding correction amount is “−50 μm” based on the data of FIG. 21. Accordingly, in this case, 50 μm is subtracted from the position of the end portion of the print medium obtained based on the detection result of the first sensor 36.

### Modification

Although not particularly described in the above-mentioned explanation, for example, the printing apparatus 10 may be configured to be capable of selectively executing the technique according to the third embodiment and the technique according to the fourth embodiment depending on the various print conditions. Specifically, in the case where the movement speed of the first sensor 36 in the passing of the end portion of the print medium is lower than a predetermined speed, the correction error is large. Accordingly, the stop position of the carriage 32 is changed by the technique of the third embodiment. Meanwhile, in the case where the movement speed is equal to or higher than the predetermined speed, the position of the end portion of the print medium M obtained based on the detection result of the first sensor 36 is corrected by the technique of the fourth embodiment. Note that the movement speed of the first sensor 36 in the passing of the end portion of the print medium M is obtained based on the print conditions.

Accordingly, in the case where the print job is inputted in this case, the printing apparatus 10 first determines whether a condition that the movement speed of the first sensor 36 in the passing of the end portion of the print medium Min the printing executed in the print job is constant is satisfied or not, based on the print conditions. If the printing apparatus 10 determines that the condition of the movement speed being constant is satisfied, the printing apparatus 10 obtains the movement speed of the first sensor 36 in the passing of the end portion of the print medium M based on the print conditions, and determines whether the obtained movement speed is equal to or higher than the predetermined speed. Then, if the printing apparatus 10 determines that the movement speed is equal to or higher than the predetermined speed, the position of the end portion of the print medium M obtained in each operation of the scanning involving printing is corrected based on the held data. Meanwhile, if the printing apparatus 10 determines that the movement speed is lower than the predetermined speed, the stop position of the carriage 32 is changed in each operation of the scanning involving printing.

In the above-mentioned explanation, execution of the correction of the detection position is not limited to execution in the detection of the end portion ER by the first sensor 36. For example, the correction may be executed in the detection of the end portion EL of the print medium Min the single mode of the second sensor 38.

### Fifth Embodiment

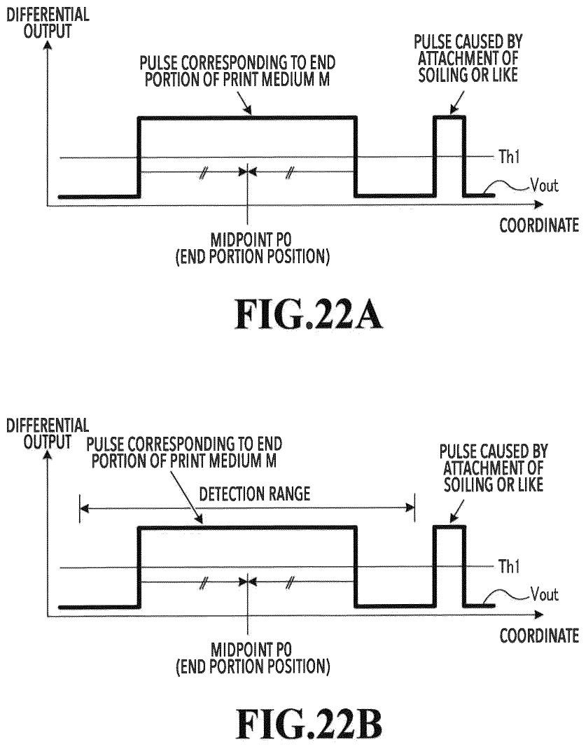

Next, a printing apparatus according to a fifth embodiment is explained with reference to FIGS. 22A to 25B. In the following explanation, configurations identical or corresponding to the configurations of the printing apparatus according to the first embodiment described above are denoted by the same reference numerals as the reference numerals used in the first embodiment, and detailed explanation thereof is omitted.

As described above, the printing apparatus 10 detects the end portion position of the print medium M based on the changes in the differential signal corresponding to the outputs from the second sensor 38 that is an optical sensor. However, in the output voltages from the second sensor 38 and the differential signal outputted from the differential amplifier 332, abnormal output or unnecessary output occurs in some cases due to various factors. In the present embodiment, a position close to the actual end portion position of the print medium M can be obtained as the end portion position of the print medium M also in the case where such anomaly or the like occurs in the outputs.

### First Form

As described above, since the second sensor 38 is an optical sensor, in the case where ink soiling, paper dust, a reflection object, or the like is attached onto the print medium M and the platen 34, a pulse caused by this attached object is formed in the waveform indicating the changes in the differential signal Vout.

For example, there is a case where soiling such as dust or ink is attached onto the print medium M or the platen 34, near the end portion of the print medium M supported on the platen 34. In this case, a pulse caused by this soiling is formed separately from the pulse corresponding to the end portion of the print medium M, in the output waveform indicating the changes in the differential signal Vout (see FIG. 22A). FIG. 22A is a diagram illustrating the output waveform indicating the changes in the differential signal Vout in the case where soiling such as dust or ink is attached to the print medium M or the platen 34, near the end portion of the print medium M supported on the platen 34. Note that, in FIGS. 22A, 22B, 24A, 24B, 24C, 24D, 25A, and 25B, the shape of the output waveform (pulse waveform) indicating the changes in the differential signal Vout is illustrated in a simplified manner to facilitate understanding.

In this case, for example, in the case where the width of the pulse caused by the soiling is about the same as the width of the pulse corresponding to the end portion of the print medium M, there is a possibility that the end portion of the print medium M in the X direction cannot be accurately detected by using the technique according to the second embodiment described above. Note that the width of pulse means the distance between the two points where the differential signal Vout passes the first threshold Th1 in one pulse.

### Outline of Obtaining of End Portion Position of Print Medium

Accordingly, in a first form of the fifth embodiment, accurate obtaining of the end portion position of the print medium in the X direction is made possible also in the case where the pulse generated by soiling as described above and the pulse corresponding to the end portion of the print medium M are generated to have similar widths.

Specifically, in the present embodiment, a detection range is provided, and a pulse outside this detection range is excluded from the pulse corresponding to the end portion of the print medium M (see FIG. 22B). FIG. 22B is a diagram illustrating a pulse excluded in the case where the detection range is provided. The detection range is a range in the width direction (X direction) of the print medium M, and is set based on a reference position (conveyance position of the print medium) in the conveyance of the print medium, the size of the print medium to be used, and the like. Alternatively, the configuration may be such that the position of the print medium M conveyed by the conveyance part is read in advance by the first sensor 36 or the second sensor 38, and the detection range is determined based on the read information. Note that, as specific coordinate values, for example, a coordinate value on the one side and a coordinate value on the other side of the detection range in the X direction are determined with an alignment position of the carriage 32 being a point of origin.

For example, in the case where the reference position in the conveyance of the print medium M is one end portion of a conveyance path in the X direction, a first position corresponding to this one end portion and a second position away from the one end portion by a size of the print medium M to be used are obtained. Then, a predetermined range about the first position is set as the detection range corresponding to the one end portion, and a predetermined range about the second position is set as the detection range corresponding to the other end portion.

Moreover, in the case where the reference position in the conveyance of the print medium M is at the center position of the conveyance path in the X direction, positions of two points centered about this center position and located away from each other in the X direction by a distance corresponding to the size of the print medium M to be used are obtained. Then, a predetermined range about one of the positions is set as the detection range corresponding to the one end portion, and the predetermined range about the other position is set as the detection range corresponding to the other end portion.

For example, the predetermined range is determined depending on the distance between the first light receiving part 322 and the second light receiving part 324. Specifically, for example, the predetermined range is set to be a range longer than this distance by a predetermined amount. Note that, in the case where the second sensor 38 is configured to detect only one end portion of the print medium M, only the detection range corresponding to the one end portion is set.

### Obtaining Process

Next, explanation is given of an obtaining process of obtaining the end portion of the print medium M f the differential signal Vout of the differential amplifier 332 in the differential mode in the present embodiment. Note that the obtaining process explained below is started after the start of the n-th scanning involving printing in S1104 in the above-mentioned printing process, and is executed, for example, in S1108.

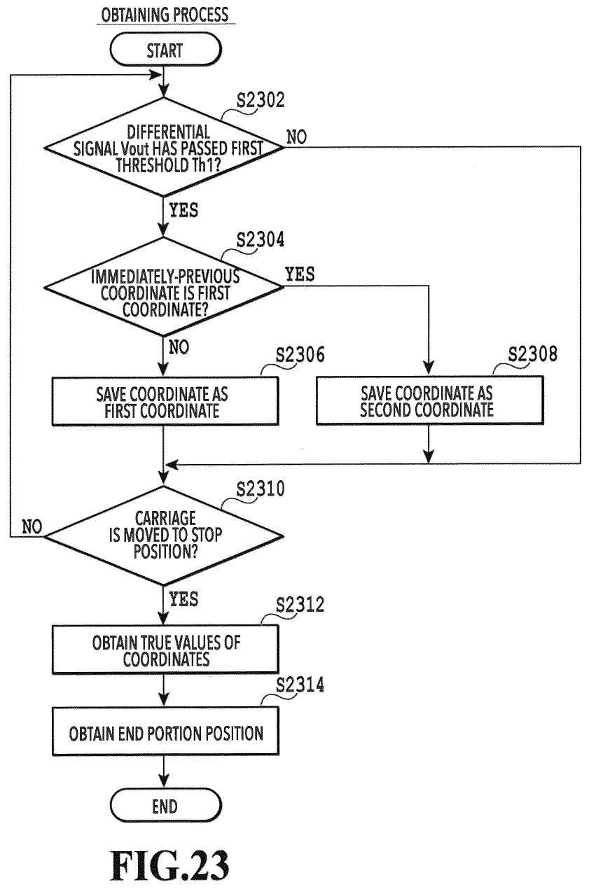

FIG. 23 is a flowchart illustrating details of the obtaining process in which the end portion of the print medium M is obtained based on the differential signal Vout in the present embodiment. The main controller 400 performs a series of processes illustrated in the flowchart of FIG. 23 by expanding program codes stored in the flash ROM 402 on the RAM 404 and executing the program codes. Alternatively, some or all of functions of steps in FIG. 23 may be executed by hardware such as an ASIC or an electric circuit.

In the case where the obtaining process is started, first, in S2302, the main controller 400 determines whether the obtained differential signal Vout of the differential amplifier 332 has passed the first threshold Th1 or not. If the main controller 400 determines that the differential signal Vout has not passed the first threshold Th1 in S2302, the process proceeds to S2310 to be described later. Meanwhile, if the main controller 400 determines that the differential signal Vout has passed the first threshold Th1 in S2302, the process proceeds to S2304, and the main controller 400 determines whether the immediately-previous obtained coordinate is the first coordinate or not.

If the main controller 400 determines that the immediately-previous obtained coordinate is not the first coordinate in S2304, the process proceeds to S2306, the main controller 400 holds the coordinate obtained in S2302 as the first coordinate, and the process proceeds to S2310. Meanwhile, if the main controller 400 determines that the immediately-previous obtained coordinate is the first coordinate in S2304, the process proceeds to S2308, the main controller 400 holds the coordinate obtained in S2302 as the second coordinate, and the process proceeds to S2310. Note that, in S2308, the held second coordinate is associated with the immediately-previous obtained first coordinate.

In S2310, the main controller 400 determines whether the carriage 32 is moved to the stop position or not. Note that, since the specific contents of the processes from S2302 to S2310 are the same as those of S1402 to S1410 described above, detailed explanation thereof is omitted. If the main controller 400 determines that the carriage 32 is not moved to the stop position in S2310, the process returns to S2302. Meanwhile, if the main controller 400 determines that the carriage 32 is moved to the stop position in S2310, the process proceeds to S2312, and the main controller 400 obtains one pair of the first coordinate and the second coordinate as the true values of the coordinates, from among the obtained pairs of the first coordinates and the second coordinates, based on the detection range set in advance.

In S2312, the first coordinate and the second coordinate that are associated with each other and that are both within the detection range are obtained as the true values of the coordinates. Note that the detection range is stored in the storage region. Then, in S2314, the main controller 400 obtains the end portion of the print medium M based on the first coordinate and the second coordinate set as the true values, and terminates this obtaining process. Since specific contents of the process of S2314 are the same as those of S1414 described above, detailed explanation thereof is omitted.

### Modification

In the obtaining process of FIG. 23, the coordinates at which the differential signal Vout passes the first threshold Th1 are obtained, and the position of the end portion of the print medium M is obtained based on the two coordinates in the detection range that are associated with each other. However, the present disclosure is not limited to this. For example, the configuration may be such that the printing apparatus 10 monitors whether the coordinate is inside the detection range or not, obtains the coordinate at which the differential signal Vout has passed the first threshold Th1 in the case where the coordinate is inside the detection range, and does not obtain the coordinate in the case where the coordinate is outside the detection range. Moreover, in the case where multiple pairs of the first coordinates and the second coordinates associated with one another are generated in the detection range in the process of S2312, for example, the coordinates in the pair in which the distance between the two coordinates are closest to the theoretical value may be obtained as the true values by using the technique of the second embodiment described above.

### Second Form

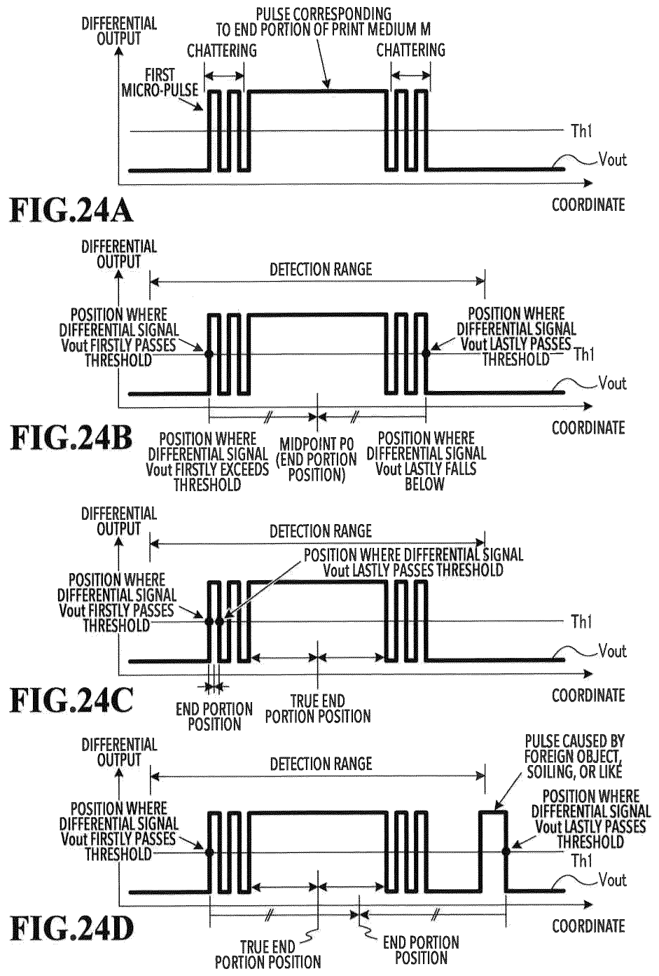

Next, a second form of the fifth embodiment is explained. As explained also in the above-mentioned second embodiment, there is a case where a micro-pulse is formed near the pulse corresponding to the end portion of the print medium M in the output waveform of the differential amplifier 332 due to fluctuation, noise, or the like in the sensor signals. There is a possibility that the end portion of the print medium M in the X direction cannot be accurately detected due to effects of the micro-pulse as described above. Specifically, for example, there is a possibility that a midpoint of two points where the differential signal Vout passes the first threshold Th1 in a first micro pulse is obtained as the end portion of the print medium M (see FIG. 24A). FIG. 24A is a diagram illustrating an output waveform expressing changes in the differential signal Vout in which micro-pulses (chattering) are formed near the pulse waveform corresponding to the end portion of the print medium M.

### Specific Technique in Present Form

Accordingly, in the second form, a midpoint between a position (point) where the differential signal Vout firstly exceeds the first threshold Th1 and a position (point) where the differential signal Vout lastly falls below the first threshold Th1 in the detection range set in the first form is obtained as the end portion position of the print medium Min the X direction (see FIG. 24B). In this case, for example, in S2308 of the obtaining process of FIG. 23, the held second coordinate does not have to be associated with the lastly-obtained first coordinate. Moreover, in S2312, the first coordinate and the last second coordinate obtained in the detection range are obtained as the true values of the coordinates.

Moreover, in this case, micro-pulses occurring before and after the pulse corresponding to the end portion of the print medium cause the distance between the coordinates obtained as the true values to be larger than the width of the pulse corresponding to the end portion of the print medium M. However, an error is smaller than that in the case where the technique of the second form is not used and a midpoint between two points where the differential signal Vout passes the first threshold Th1 in the firstly-occurring micro-pulse is obtained as the position of the end portion of the print medium M (see FIG. 24C). Moreover, since the chattering occurs at high speed (in a short period), even in the case where the chattering portion is included in the pulse to be detected (two points for obtaining the midpoint), an error occurs at an ignorable level.

In the technique according to the second form, the case where the position of the end portion of the print medium M is detected based on, for example, a micro-pulse firstly occurring in the detection range thereby does not occur (see FIG. 24C). Moreover, the case where the position of the end portion of the print medium M is detected outside the detection range based on the position where the differential signal Vout lastly falls below the threshold does not occur (see FIG. 24D).

### Third Form

Next, a third form of the fifth embodiment is explained. There is a case where signal deterioration occurs in the differential signal Vout due effects of light reflection caused by soiling on the platen 34 or the like, and the distance between two points where the differential signal Vout firstly and lastly passes the threshold becomes shorter or longer than the distance in the case where no signal deterioration occurs. In this case, the position of the end portion of the print medium M cannot be accurately detected.

### Specific Technique in Present Form

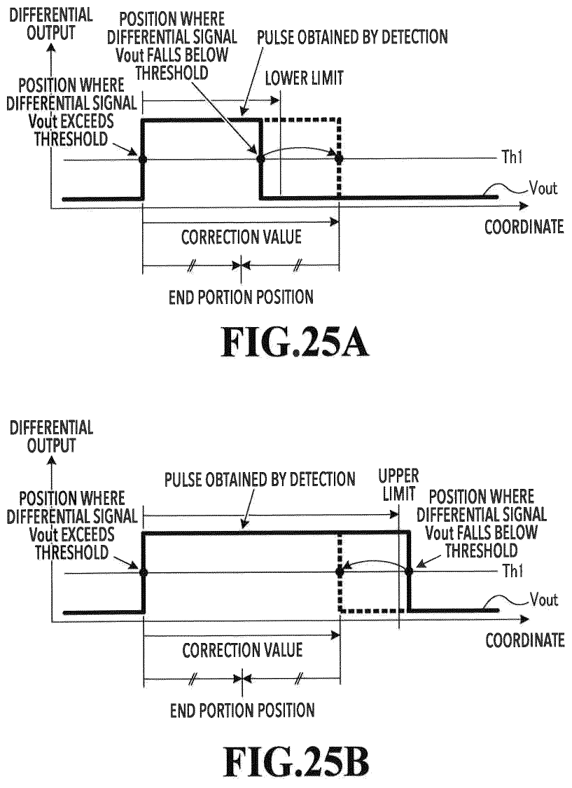

Accordingly, in the third form, the pulse width of the pulse corresponding to the end portion of the print medium M is set, and in the case where the pulse width of the pulse obtained by the detection is shorter (or longer) than the set pulse width, the obtained pulse width is corrected. Explanation is given below in detail with reference to FIGS. 25A and 25B. FIGS. 25A and 25B are diagrams explaining specific technical contents in the third form of the fifth embodiment, FIG. 25A is a diagram explaining a technique in the case where the pulse width obtained in the detection is short, and FIG. 25B is a diagram explaining a technique in the case where the pulse width obtained in the detection is long.

Specifically, the pulse width of the pulse corresponding to the end portion of the print medium M is set based on the positional relationship between the first light receiving part 322 and the second light receiving part 324, that is the distance between the center position of the first light receiving part 322 and the center position of the second light receiving part 324 in the X direction. A range in which the distance between the position where the differential signal Vout exceeds the first threshold Th1 and the position where the differential signal Vout falls below the first threshold Th1 in the pulse corresponding to the end portion of the print medium M is considered as an allowable distance is set as a setting value (setting range). Moreover, a correction value for correcting the position where the differential signal Vout falls below the first threshold Th1 is set. This correction value is a value that corresponds to the positional relationship between the first light receiving part 322 and the second light receiving part 324, and is, for example, a value that causes the position where the differential signal Vout falls below the first threshold Th1 to be away from the position where the differential signal Vout exceeds the first threshold Th1 by a distance in which the position of the end portion of the print medium M can be properly obtained. Note that this correction value is at least a value in the range set as the setting value. This correction value is determined, for example, through experiments depending on the types of the print medium M and the like.

Assume that the width of the pulse corresponding to the end portion of the print medium M and obtained by the detection, that is the distance between the position where the differential signal Vout exceeds the first threshold Th1 and the position where the differential signal Vout falls below the first threshold Th1 is smaller than a lower limit value of the set pulse width. In this case, the position where the differential signal Vout falls below the first threshold Th1 is moved in a direction away from the position where the differential signal Vout exceeds the first threshold Th1, based on the set correction value such that the distance between the position where the differential signal Vout exceeds the first threshold Th1 and the position where the differential signal Vout falls below the first threshold Th1 becomes the correction value (see FIG. 25A). Then, the end portion position of the print medium M is obtained based on the position where the differential signal Vout exceeds the first threshold Th1 and the position where the differential signal Vout falls below the first threshold Th1 after the movement. Specifically, in this case, the position where the differential signal Vout falls below the first threshold Th1 is corrected based on the correction value with respect to the position where the differential signal Vout exceeds the first threshold Th1, and the distance between the position where the differential signal Vout exceeds the first threshold Th1 and the position where the differential signal Vout falls below the first threshold Th1 is thereby increased from that before the correction.

Moreover, assume that the distance between the position where the differential signal Vout exceeds the first threshold Th1 and the position where the differential signal Vout falls below the first threshold Th1 in the pulse corresponding to the end portion of the print medium M and obtained by the detection is larger than an upper limit value of the set pulse width. In this case, the position where the differential signal Vout falls below the first threshold Th1 is moved in a direction toward the position where the differential signal Vout exceeds the first threshold Th1, based on the set correction value such that the distance between the position where the differential signal Vout exceeds the first threshold Th1 and the position where the differential signal Vout falls below the first threshold Th1 becomes the correction value (see FIG. 25B). Then, the end portion position of the print medium M is obtained based on the position where the differential signal Vout exceeds the first threshold Th1 and the position where the differential signal Vout falls below the first threshold Th1 after the movement. Specifically, in this case, the position where the differential signal Vout falls below the first threshold Th1 is corrected based on the correction value with respect to the position where the differential signal Vout exceeds the first threshold Th1, and the distance between the position where the differential signal Vout exceeds the first threshold Th1 and the position where the differential signal Vout falls below the first threshold Th1 is thereby reduced from that before the correction.

Specifically, in the case where the distance between the position where the differential signal Vout exceeds the first threshold Th1 and the position where the differential signal Vout falls below the first threshold Th1 that is the width of the pulse is outside the range of the setting value, the position where the differential signal Vout falls below the first threshold Th1 is moved to a position away from the position where the differential signal Vout exceeds the first threshold Th1 by the correction value. Note that, in the case where the technique of the second form described above is used together, the “position where the differential signal Vout exceeds the first threshold Th1” in the above-mentioned explanation is the “position where the differential signal Vout firstly exceeds the first threshold Th1, and the “position where the differential signal Vout falls below the first threshold Th1” in the above-mentioned explanation is the “position where the differential signal Vout lastly falls below the first threshold Th1”.

In the above-mentioned explanation, in the case where the distance between the position where the differential signal Vout exceeds the first threshold Th1 and the position where the differential signal Vout falls below the first threshold Th1 is outside the range of the setting value, the position where the differential signal Vout falls below the first threshold Th1 is moved. However, the present disclosure is not limited to this. The position where the differential signal Vout exceeds the first threshold Th1 may be moved to a position away from the position where the differential signal Vout falls below the first threshold Th1 by the correction value. For example, assume cases such as the case where the platen 34 is more soiled than the print medium M. In this case, if the second sensor 38 detects the end portion of the print medium M while being moved from the print medium M side toward the platen 34 side in the X direction, the position where the differential signal Vout falls below the first threshold Th1 is moved. Moreover, in this case, if the second sensor 38 detects the end portion of the print medium M while being moved from the platen 34 side toward the print medium M side in the X direction, the position where the differential signal Vout exceeds the first threshold Th1 is moved.

### Operation and Effects

As explained above, in the first form of the present embodiment, there is provided the detection range for detecting the pulse corresponding to the end portion of the print medium M, and pulses formed outside the detection range are excluded in the obtaining of the position of the end portion of the print medium M. Moreover, in the second form of the present embodiment, the coordinate of the midpoint between the position where the differential signal Vout firstly exceeds the first threshold Th1 and the position where the differential signal Vout lastly falls below the first threshold Th1 in the detection range is obtained as the position of the end portion of the print medium M. Furthermore, in the third form of the present embodiment, in the case where the width of the pulse corresponding to the end portion of the print medium M is smaller than the lower limit value of the setting value or larger than the upper limit value of the setting value, the position where the differential signal Vout falls below the first threshold Th1 is moved based on the correction value. In the present embodiment, a position close to the actual end portion position of the print _medium M can be thereby obtained as the end portion position of the print medium M also in the case where abnormality or the like occurs in the outputs from the second sensor 38 and the differential amplifier 332.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to suppress an increase in a time period required for printing.

This application claims the benefit of Japanese Patent Application No. 2024-164294, filed Sep. 20, 2024, and No. 2024-206408, filed Nov. 27, 2024, which are hereby incorporated by reference herein in their entirety.

What is claimed is:

1. A printing apparatus comprising:
a supporting unit configured to support a conveyed print medium;
a carriage in which a print head configured to perform printing by ejecting ink to the print medium is mounted, the carriage movable in a width direction of the print medium intersecting a conveyance direction of the print medium;
a first detection unit provided on one side of the carriage in the width direction and capable of detecting an end portion of the print medium in the width direction; and
a second detection unit provided on the other side of the carriage in the width direction and capable of detecting the end portion of the print medium in the width direction, wherein
at least one of the first detection unit and the second detection unit includes:
a light emitting unit configured to emit light to the supporting unit and the print medium supported on the supporting unit;
a first light receiving unit capable of receiving reflected light from the supporting unit and the print medium supported on the supporting unit; and
a second light receiving unit capable of receiving the reflected light from the supporting unit and the print medium supported on the supporting unit, the second light receiving unit overlapping the first light receiving unit in the conveyance direction and spaced apart from the first light receiving unit in the width direction.

2. The printing apparatus according to claim 1, further comprising an output unit configured to amplify a difference between an output from the first light receiving unit and an output from the second light receiving unit and output the difference.

3. The printing apparatus according to claim 2, further comprising an obtaining unit configured to obtain an end portion position of the print medium in the width direction based on an output value of the output unit in movement of the carriage in the width direction.

4. The printing apparatus according to claim 3, wherein the obtaining unit obtains a midpoint of two points where the output value from the output unit passes a threshold, as the end portion position.

5. The printing apparatus according to claim 1, wherein the at least one of the first detection unit and the second detection unit including the light emitting unit, the first light receiving unit, and the second light receiving unit further includes a third light receiving unit capable of receiving the reflected light from the supporting unit and the print medium supported on the supporting unit, the third light receiving unit provided between the first light receiving unit and the second light receiving unit in the width direction.

6. The printing apparatus according to claim 5, further comprising an output unit configured to amplify outputs from the first light receiving unit, the second light receiving unit, and the third light receiving unit and perform output, wherein
the output unit includes:
a first amplification unit configured to amplify a difference between an output from the first light receiving unit and an output from the second light receiving unit, and
a second amplification unit configured to amplify the output from the third light receiving unit and output the output.

7. The printing apparatus according to claim 6, further comprising an obtaining unit configured to obtain an end portion position of the print medium in the width direction based on an output value from the output unit in movement of the carriage in the width direction, wherein
the obtaining unit
obtains a midpoint between two points where an output value from the first amplification unit passes a first threshold, as the end portion position, and
obtains a point where an output value from the second amplification unit passes a second threshold, as the end portion position.

8. The printing apparatus according to claim 1, further comprising a print control unit configured to perform printing by alternately executing first printing and second printing, the first printing being printing in which the ink is ejected from the print head while the carriage is moved in a first direction from the one side toward the other side in the width direction, the second printing being printing in which the ink is ejected from the print head while the carriage is moved in a second direction from the other side toward the one side in the width direction, wherein
the first detection unit detects a first end portion located on the one side of the print medium in the width direction in execution of the second printing, and
the second detection unit detects a second end portion located on the other side of the print medium in the width direction in execution of the first printing.

9. The printing apparatus according to claim 8, further comprising:
an obtaining unit configured to obtain a position of the first end portion based on a detection result of the first detection unit and obtain a position of the second end portion based on a detection result of the second detection unit; and
a determination unit configured to determine the position of the first end portion obtained in the obtaining unit as a printing start position in execution of the immediately subsequent first printing and determine the position of the second end portion obtained in the obtaining unit as a printing start position in execution of the immediately-subsequent second printing.

10. The printing apparatus according to claim 4, wherein the obtaining unit
sets the two points where the output value from the output unit passes the threshold and that correspond to each other, as one pair, and
obtains a midpoint of the two points where the output value from the output unit passes the threshold and that form the pair in which a distance between the two points is closest to a predetermined value, as the end portion position.

11. The printing apparatus according to claim 4, wherein the obtaining unit
sets the two points where the output value from the output unit passes the threshold and that correspond to each other, as one pair, and
obtains a midpoint of the two points where the output value from the output unit passes the threshold and that form the pair in which a difference between a distance between the two points and a predetermined value is equal to or less than a first value, as the end portion position.

12. The printing apparatus according to claim 10, wherein the predetermined value is a distance between the first light receiving unit and the second light receiving unit in the width direction.

13. The printing apparatus according to claim 11, wherein the first value is a predetermined proportion to the predetermined value.

14. The printing apparatus according to claim 1, further comprising a changing unit configured to change, in an operation in which the first detection unit detects the end portion of the print medium on the one side in the width direction as printing is performed by ejecting the ink from the print head while moving the carriage in a predetermined direction from the other side toward the one side in the width direction, a set stop position of the carriage to a downstream position in the predetermined direction, wherein
the first detection unit includes
a light emitting unit configured to emit light to the supporting unit and the print medium supported on the supporting unit; and
a light receiving unit capable of receiving reflected light from the supporting unit and the print medium supported on the supporting unit.

15. The printing apparatus according to claim 14, wherein
the stop position changed by the changing unit is apart from a position corresponding to the end portion by a predetermined distance, and
the predetermined distance is a distance from start of deceleration of the carriage to stop of the carriage or a distance longer than the distance from start of deceleration of the carriage to stop of the carriage by a fixed amount.

16. The printing apparatus according to claim 15, wherein the position corresponding to the end portion is a position of the end portion obtained based on a detection result detected in the first detection unit in the immediately-previous operation.

17. The printing apparatus according to claim 1, wherein
the first detection unit includes:
a light emitting unit configured to emit light to the supporting unit and the print medium supported on the supporting unit; and
a light receiving unit capable of receiving reflected light from the supporting unit and the print medium supported on the supporting unit, and
the printing apparatus further comprises:
an obtaining unit configured to obtain a point where an output from the light receiving unit passes a threshold, as an end portion position of the print medium on the one side in the width direction; and
a correction unit configured to correct the end portion position obtained by the obtaining unit.

18. The printing apparatus according to claim 17, wherein the correction unit determines a correction amount based on a difference between a reference speed and a movement speed of the carriage in passing of the end portion by the first detection unit.

19. The printing apparatus according to claim 18, wherein the movement speed of the carriage in the passing of the end portion by the first detection unit is obtained based on a print condition.

20. The printing apparatus according to claim 19, further comprising a changing unit configured to change, in an operation in which the first detection unit detects the end portion as printing is performed by ejecting the ink from the print head while moving the carriage in a predetermined direction from the other side toward the one side in the width direction, a set stop position of the carriage to a downstream position in the predetermined direction, wherein
the changing unit changes the stop position in the case where the movement speed of the carriage in the passing of the end portion by the first detection unit is lower than a predetermined speed, and
the correction unit corrects the end portion position in the case where the movement speed of the carriage in the passing of the end portion by the first detection unit is equal to or higher than the predetermined speed.

21. A control method of a printing apparatus including:
a supporting unit configured to support a conveyed print medium;
a carriage in which a print head configured to perform printing by ejecting ink to the print medium is mounted, the carriage movable in a width direction of the print medium intersecting a conveyance direction of the print medium;
a first detection unit provided on one side of the carriage in the width direction and capable of detecting an end portion of the print medium in the width direction; and
a second detection unit provided on the other side of the carriage in the width direction and capable of detecting the end portion of the print medium in the width direction,
at least one of the first detection unit and the second detection unit including:
a light emitting unit configured to emit light to the supporting unit and the print medium supported on the supporting unit;
a first light receiving unit capable of receiving reflected light from the supporting unit and the print medium supported on the supporting unit; and
a second light receiving unit capable of receiving the reflected light from the supporting unit and the print medium supported on the supporting unit, the second light receiving unit overlapping the first light receiving unit in the conveyance direction and spaced apart from the first light receiving unit in the width direction, the control method comprising:
causing the first detection unit to detect a first end portion located on the one side of the print medium in the width direction in execution of first printing in which the ink is ejected from the print head while the carriage is moved in a direction from the other side toward the one side in the width direction; and
causing the second detection unit to detect a second end portion located on the other side of the print medium in the width direction in execution of second printing in which the ink is ejected from the print head while the carriage is moved in a direction from the one side toward the other side in the width direction.

22. The control method according to claim 21, wherein a position of the first end portion obtained based on a detection result of the first detection unit is set as a printing start position in execution of the immediately-subsequent second printing, and a position of the second end portion obtained based on a detection result of the second detection unit is set as a printing start position in execution of the immediately-subsequent first printing.

23. The printing apparatus according to claim 4, wherein the obtaining unit obtains the midpoint between the two points where the output value from the output unit passes the threshold in a detection range for detecting the end portion position and that correspond to each other, as the end portion position.

24. The printing apparatus according to claim 4, wherein the obtaining unit obtains a midpoint between a point where the output value from the output unit firstly exceeds the threshold and a point where the output value from the output unit lastly falls below the threshold in a detection range for detecting the end portion position, as the end portion position.

25. The printing apparatus according to claim 23, wherein the detection range is set based on a conveyance position of the print medium and a size of the print medium or based on a detection result of the conveyed print medium in the first detection unit or the second detection unit.

26. The printing apparatus according to claim 4, wherein
the obtaining unit sets a first point where the output value from the output unit exceeds the threshold and a second point where the output value falls below the threshold immediately after the first point, as a correspondence pair, and
in a case where a distance between the two points in the correspondence pair is outside a setting range, moves the second point to a position away from the first point by a predetermined value, and obtains a midpoint between the first point and the moved second point, as the end portion position.

27. The printing apparatus according to claim 4, wherein the obtaining unit
sets a first point where the output value from the output unit exceeds the threshold and a second point where the output value falls below the threshold immediately after the first point, as a correspondence pair, and
in a case where a distance between the two points in the correspondence pair is outside a setting range, moves the first point to a position away from the second point by a predetermined value, and obtains a midpoint between the moved first point and the second point as the end portion position.

28. The printing apparatus according to claim 26, wherein the setting range is a value corresponding to a distance between the first detection unit and the second detection unit in the width direction, and is a range of a distance from the first point in which the end portion position is obtainable.

29. The printing apparatus according to claim 26, wherein the predetermined value is a value that causes the second point to be spaced away from the first point by a distance in which the end portion position is obtainable, depending on a positional relationship between the first detection unit and the second detection unit.
